(19) United States
(12) Patent Application Publication
(10) Pub. No.: US 2025/0285550 A1
(43) Pub. Date: Sep. 11, 2025

(54) AUTOMATIC SELECTION OF TERM STUDY DIRECTION

(71) Applicant: Quizlet, Inc., San Francisco, CA (US)

(72) Inventor: Tingting Lin, San Francisco, CA (US)

(21) Appl. No.: 18/769,964

(22) Filed: Jul. 11, 2024

Related U.S. Application Data
(60) Provisional application No. 63/563,831, filed on Mar. 11, 2024.

(51) Int. Cl. G09B 7/06; G06N 20/00; G09B 7/02

(52) U.S. Cl. CPC G09B 7/066; G06N 20/00; G09B 7/02

(57) ABSTRACT

A computer-implemented method includes receiving a set of flashcards, each flashcard in the set having a first side and a second side, and classifying, using a first machine learning model, each flashcard of the set as either a Multiple Choice Question (MCQ) flashcard, a True/False flashcard, a Fill-In-The-Blank flashcard, a Pure Question flashcard, a Raw flashcard or a Solution flashcard. The method further includes determining a study direction for a flashcard from the set of flashcards by determining which one of the first side or the second side of the flashcard is a prompt side that is presented to a user prior to a response side. For the MCQ flashcard and the True/False flashcard, determining the study direction using a second machine learning model and for other flashcard type determining the study direction using a rule-based model.

### BENEFIT CLAIM

This application claims the benefit under 35 U.S.C. § 119 (e) of provisional application 63/563,831, filed Mar. 11, 2024, the entire contents of which are hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights. © 2024 Quizlet, Inc.

### TECHNICAL FIELD

One technical field of the present disclosure is machine learning algorithms and computational systems applied to educational problems.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Modern online learning systems have significantly improved targeted instruction, making it more accessible across a wide range of subjects than ever before. Beyond traditional educational settings, diverse groups of students worldwide can now learn without needing a physical classroom. Often, online learning systems can leverage user-generated content data to facilitate the study of various concepts. However, such data frequently requires analysis for accuracy and formatting before being presented to students. The present disclosure aims to address some of the challenges associated with analyzing and formatting user-generated content data, alongside effectively presenting this data to students in a manner that enhances learning.

### SUMMARY

The appended claims may serve as a summary of the disclosure.

### BRIEF DESCRIPTION OF THE DRAWINGS

In the drawings:

FIG. 1A is a distributed computer system showing the context of use and principal functional elements with which one embodiment could be implemented, according to an embodiment.

FIG. 1B is an example method of using flashcards in different learning modes, according to an embodiment.

FIG. 2A is an example workflow pipeline for processing term-related data, according to an embodiment.

FIG. 2B is an example workflow pipeline for processing term-related data to obtain a term classification, according to an embodiment.

FIG. 3 is an example method for determining a study direction.

FIG. 4 illustrates a computer system that can be used to implement an embodiment.

### DETAILED DESCRIPTION

In the following description, numerous specific details are set forth in order to provide a thorough understanding of the present disclosure. It will be apparent, however, that the present disclosure may be practiced without these specific details. In other instances, well-known structures and devices are shown in block diagram form to avoid unnecessarily obscuring the present disclosure.

The text of this disclosure, in combination with the drawing figures, is intended to state in prose the algorithms that can be used to program the computer to implement the disclosure at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the disclosure described herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

In various embodiments of the disclosure, the term “set” denotes a grouping or collection of objects, elements, components, or entities. The flexibility in interpreting the term “set” allows for adaptability and practical application in situations where a singular object satisfies the intended functionality or purpose of the disclosure. Thus, the disclosure is not limited to instances where a “set” must consist of multiple elements but rather contemplates scenarios where a “set” may include one element.

Online learning systems have emerged as powerful tools for expanding educational opportunities and democratizing access to knowledge. These systems offer a wealth of resources and instructional materials across a wide range of subjects, allowing learners to engage with educational content from anywhere in the world. However, ensuring the quality and relevance of the content presented on these platforms remains a significant challenge, particularly when it comes to user-generated content data, which questions and associated answers can represent.

Integration of machine learning models designed to differentiate between questions and answers within user-generated content offers a technical solution to the problem of evaluating and organizing user-generated content. By leveraging advanced algorithms, these machine-learning models can automatically identify and flag inadequate questions or answers, streamlining the content curation process and enhancing the overall learning experience for users. For instance, if a user-generated question is overly lengthy or lacks clarity, the model can promptly flag it as inadequate, preventing learners from encountering confusing or irrelevant content. Similarly, incorrect or incomprehensible answers can be swiftly identified and addressed, mitigating the dissemination of misinformation.

Moreover, both machine-learning models and rule-based models can be employed to determine a possibly preferred method of presenting learning material. For instance, when the learning material comprises flashcards, identifying the most effective approach for presenting such flashcards (e.g., determining which side of a flashcard should be displayed first) can greatly enhance the learning process.

Furthermore, the streamlined content curation process made possible by machine learning models enables more questions to be presented to students, enriching their learning experiences with a broader range of relevant and high-quality material. Ultimately, integrating machine learning technology into online learning systems represents a significant stride in computer technology, empowering educational platforms to deliver more accurate, informative, and engaging learning experiences while optimizing resource utilization and scalability.

The machine-learning models outlined in this disclosure are specially trained for analyzing user-generated content presented as flashcards, which consist of a first side containing a first data record and a second side containing a second data record. For instance, the first data record may represent a question, while the second data record serves as the corresponding answer. Sometimes, the first data record could be a specific word or phrase, with the second data record offering its definition. In various scenarios, the first data record is designed to be contextually linked to the second data record, implying a connection based on shared meaning or closely related content. This contextual linking ensures that two items convey similar or related ideas; for example, a question is contextually linked to its answer, and the definition of a word is contextually linked to the word itself.

Moreover, these machine-learning models are trained to classify the types of questions presented in flashcards and determine whether the first data record or the second data record should be presented to the user first, thereby enhancing the learning experience. Through training with specific examples of flashcards, as detailed below, these models significantly improve the functionality of a computer. Additionally, they are configured for integration into a system that provides flashcards to students containing learning material for study purposes. This system is further refined by incorporating various pre- and post-processing capabilities for analyzing user-generated content data and enhancing the quality of the flashcards.

The disclosure encompasses the subject matter of the following numbered clauses:

1. A computer-implemented method comprising: receiving a set of flashcards, each flashcard in the set of flashcards having a first side and a second side; classifying, using a first machine learning model, one or more flashcards of the set of flashcards, the classifying including determining a particular flashcard type of each of the one or more flashcards, wherein the particular flashcard type is a multiple choice question (MCQ) flashcard, a True/False flashcard, a Fill-In-The-Blank flashcard, a Pure Question flashcard, a Raw flashcard, or a Solution flashcard, and wherein the first machine learning model is trained using a first training set of flashcards and each flashcard of the first training set has an associated label corresponding to an (MCQ flashcard, a True/False flashcard, a Fill-In-The-Blank flashcard, a Pure Question flashcard, a Raw flashcard, or a Solution flashcard; and determining that a flashcard of the one or more flashcards has been classified as an MCQ flashcard by the first machine learning model; and determining a study direction for the flashcard using a second machine learning model; wherein determining the study direction for the flashcard comprises determining which one of the first side or the second side of the flashcard is a prompt side that is presented to a user prior to a response side; and wherein the second machine learning model is trained using a second training set of flashcards and each flashcard of the second training set of flashcards has a flashcard side that is labeled as a prompt side or a response side.

2. The computer-implemented method of clause 1, wherein the first machine learning model is configured to extract one or more flashcard features including one or more bullets or a question mark, wherein the one or more flashcard features comprise an input to the second machine learning model.

3. The computer-implemented method of clause 2, further comprising one or more of: determining a language for each side of the flashcard, determining whether a side of the flashcard includes a numerical value, or determining a number of tokens of the first and the second side of the flashcard.

4. The computer-implemented method of clause 1, wherein the flashcard is a first flashcard, the computer-implemented method further comprising determining that a second flashcard of the one or more flashcards has been classified as a is Fill-In-The-Blank flashcard, a Pure Question flashcard, a Raw flashcard, or a Solution flashcard and determining a study direction for the second flashcard using a rule-based model.

5. The computer-implemented method of clause 4, wherein the rule-based model includes instructions comprising determining that the first or the second side of the second flashcard contains a question and, in response, selecting the side of the second flashcard containing the question as a prompt side of the second flashcard.

6. The computer-implemented method of clause 5, wherein the determining that the first or the second side of the second flashcard contains the question comprises at least one of: identifying a question mark in text of the first side or the second side of the second flashcard; identifying interrogative pronouns in the text of the first side or the second side of the second flashcard; or identifying an inverted word order present within the text of the first side or the second side of the second flashcard.

7. The computer-implemented method of clause 4, wherein the rule-based model includes instructions comprising: determining that the second flashcard has been classified as a Fill-In-The-Blank flashcard type; identifying a blank space in a text of the first side or the second side of the second flashcard; and selecting a side of the second flashcard containing the identified blank space as a prompt side of the second flashcard.

8. The computer-implemented method of clause 1, wherein the flashcard is a first flashcard, the computer-implemented method further comprising determining that a second flashcard of the one or more flashcards has been classified as a True/False flashcard and identifying a response side of the second flashcard as the side of the flashcard that includes words “True” or “False” and has a length of a text that is less than a predetermined true-false threshold value.

9. The computer-implemented method of clause 1, wherein the set of flashcards includes a plurality of flashcards, the method further comprising: determining a set-level preference study direction for the set of flashcards; and based on a determination that the study direction for the flashcard does not match the set-level preference study direction, replacing the study direction for the flashcard with the set-level preference study direction.

10. The computer-implemented method of clause 9, wherein the determined set-level preference study direction is a selected set-level preference study direction that corresponds to a study direction for a majority of flashcards from the set of flashcards.

11. A computer-implemented method comprising: receiving a set of flashcards, each flashcard in the set of flashcards having a first side and a second side; classifying, using a first machine learning model, one or more flashcards of the set of flashcards as being of a particular flashcard type, wherein the first machine learning model is trained using a first training set of flashcards and each flashcard of the first training set has an associated label corresponding to a multiple choice question (MCQ) flashcard, a True/False flashcard, or a Fill-In-The-Blank flashcard, a Pure Question flashcard, a Raw flashcard or a Solution flashcard; determining that the particular flashcard type for a flashcard of the one or more flashcards is the Pure Question flashcard, the Raw flashcard or the Solution flashcard; and determining a study direction for the flashcard using a rule-based model, wherein the determining of the study direction for the flashcard comprises determining which one of the first side or the second side of the flashcard is a prompt side that is presented to a user prior to a response side.

12. The computer-implemented method of clause 11, wherein the rule-based model includes instructions comprising determining that the first or the second side of the flashcard contains a question and, in response, selecting the side of the flashcard containing the question as the prompt side of the flashcard.

13. The computer-implemented method of clause 12, wherein the determining that the first or the second side of the flashcard contains the question comprises at least one of: identifying a question mark in text of the first side or the second side of the flashcard; identifying interrogative pronouns in the text of the first side or the second side of the flashcard; or identifying an inverted word order present within the text of the first side or the second side of the flashcard.

14. The computer-implemented method of clause 11, wherein the rule-based model include instructions comprising: determining that the flashcard is of a Fill-In-The-Blank flashcard type; and identifying a blank space in a text of the first side or the second side of the flashcard; and selecting a side of the flashcard containing the identified blank space as the prompt side of the flashcard.

15. The computer-implemented method of clause 12, wherein the set of flashcards includes a plurality of flashcards, the method further comprises: determining a set-level preference study direction for the set of flashcards; and based on a determination that a study direction of one or more flashcards of the set of flashcards does not match the set-level preference study direction, replacing the study direction of the one or more flashcards with the set-level preference study direction.

16. The computer-implemented method of clause 15, wherein determining the set-level preference study direction includes selecting the set-level preference study direction that corresponds to the study direction for a majority of flashcards from the set of flashcards.

17. A computer-implemented method comprising: receiving a set of flashcards, each flashcard in the set of flashcards having a first side and a second side; classifying, using a first machine learning model, each flashcard of the set of flashcards as being of one of a multiple choice question (MCQ) flashcard, a True/False flashcard, a Fill-In-The-Blank flashcard, a Pure Question flashcard, a Raw flashcard, or a Solution flashcard, wherein the first machine learning model is trained using a first training set of flashcards and each flashcard of the first training set has an associated label corresponding to the multiple choice question (MCQ) flashcard, the True/False flashcard, the Fill-In-The-Blank flashcard, the Pure Question flashcard, the Raw flashcard or the Solution flashcard; and determining a study direction for a flashcard from the set of flashcards by determining which one of the first side or the second side of the flashcard is a prompt side that is presented to a user prior to a response side, wherein: for the multiple choice question (MCQ) flashcard and the True/False flashcard, performing the determining using a second machine learning model, that is being trained using a second training set of flashcards, wherein each flashcard of the second training set of flashcards has a flashcard side that is labeled as the prompt side or the response side; and for the Fill-In-The-Blank flashcard, the Pure Question flashcard, the Raw flashcard or the Solution flashcard, performing the determining using a rule-based model.

18. The computer-implemented method of clause 17, wherein the first machine learning model is configured to extract one or more flashcard features including one or more bullets or a question mark, wherein the one or more flashcard features comprise an input to the second machine learning model.

19. The computer-implemented method of clause 17, wherein the rule-based model includes instructions comprising determining that the first or the second side of a flashcard from the set of flashcards contains a question and, in response, selecting the side of the flashcard containing the question as the prompt side of the flashcard.

20. The computer-implemented method of clause 19, wherein the determining that the first or the second side of the flashcard contains the question comprises at least one of: identifying a question mark in text of the first side or the second side of the flashcard; identifying interrogative pronouns in the text of the first side or the second side of the flashcard; or identifying an inverted word order present within the text of the first side or the second side of the flashcard.

### 1. General Overview

The present disclosure describes a learning system operated as a federated collection of web-based or SaaS computer program applications. This system stores user-generated content data (UGC) in terms that represent individual flashcards and sets representing a collection of these flashcards. In this disclosure, the terms “term” and “flashcard” may be used interchangeably. Each flashcard consists of two sides: the first side presents a primary data record, referred to herein as “the word side” or “question,” and the second side presents a secondary data record, referred to herein as “the definition side” or “answer.” The learning system offers various study models, including a “flashcard” mode, a “learn” mode, or a “test” mode to study such sets of flashcards that are presented as questions that allow users to study these sets of flashcards more effectively.

In the “flashcard” mode, users can review terms and definitions or questions and answers in a manner akin to traditional flashcards. The “learn” mode, on the other hand, presents study questions that progressively increase in difficulty. This personalized study mode tailors the sequence of study based on the user's familiarity with the content, facilitating comprehensive study. Subscribers in the “learn” mode can employ custom study paths, monitor their progress, and utilize smart grading to focus on conceptual understanding rather than memorization. In the “test” mode, students can assess their performance by quizzing themselves with various question types, providing insight into their exam readiness.

End users, typically students, connect to the learning system's server processes via personal computers over the Internet. Then, dynamically generated web pages are displayed locally on their PCs through a browser. Users can select and interact with different models through web-based applications provided by the platform. In various cases, when terms are transformed into questions, such questions can be presented as flashcard questions, multiple choice questions, or written questions.

The flashcard questions are configured to display one side of a flashcard as a prompt for users to guess the other side. Herein, when referencing a flashcard, it is implied that it is digital, meaning it is represented electronically through a suitable interface within the learning system. For instance, the learning system is designed to display both the first side and the second side of a flashcard, with the transition between the two sides facilitated through a user-friendly graphical interface. This interface may include options like buttons, clicking actions on the flashcard using a mouse, or user gestures such as swiping across the flashcard.

Flashcards can be categorized into various format classifications such as multiple choice question (MCQ) flashcards, Pure Question flashcards, Fill-In-The-Blank (FITB) flashcards, Raw flashcards, and Solution flashcards. Each type serves different educational purposes and enhances learning through structured engagement. User-generated content (UGC) can be stored as individual flashcards, termed “terms,” and as collections of flashcards, known as “sets.” When engaging with these sets through different study models such as “learn”, “test”, or “flashcard”, flashcards are transformed in a set into one of several interactive question types, regardless of their original format. This approach allows users to study more effectively by adapting the content to fit one of the following types:

Flashcard Question: This model displays one side of the flashcard, prompting the user to guess the content on the other side.

Multiple-Choice Question (MCQ): In this format, one side of the flashcard is used as a prompt, and the other side, along with additional distractors, serves as multiple choice options for the user.

Written Question: Here, one side is used as a prompt, and the user is asked to provide a free response. The opposite side of the flashcard is then used as the answer to grade the user's response.

For example, for a flashcard that corresponds to a record below:

| Answer | Prompt |
|---|---|
| John Adams | Massachusetts patriot leader; defended British |
| | soldiers in Boston massacre; helped draft |
| | declaration of independence. |

a Flashcard Question will show in “flashcard” mode:

| | |
|---|---|
| John Adams | Massachusetts patriot leader; defended British |
| | soldiers in Boston massacre; helped draft |
| | declaration of independence. |

And MCQ will show in the “learn” or “test” mode:

Massachusetts patriot leader; defended British soldiers in Boston massacre;
helped draft declaration of independence.
Chose matching term:

| | |
|---|---|
| (1) Samuel Adams | (2) James Madison |
| (3) John Adams | (4) Thomas Jefferson |
| (3) John Adams | |

Further, a Written Question will show in the “learn” or “test” mode:

Massachusetts patriot leader; defended British soldiers in Boston massacre;
helped draft declaration of independence.
Your Answer
Type Your Answer

As shown above, the multiple choice questions can be set up to utilize the first side of a flashcard as a prompt with distractors (e.g., options such as (1) Samuel Adams, (2) James Madison, and (4) Thomas Jefferson, as shown above) as options for the user to choose from. Herein, distractors are defined as potential answers to the question displayed on the first side of the flashcard, which may not be correct. Note that for a flashcard that is already a MCQ, the options presented in such a flashcard can be used directly with a user interface (UI). For a flashcard that's not an MCQ, a distractor generation service is used to generate plausible options for the flashcard and show the generated options in the (UI). The distractor generation service may be configured to generate distractors for a prompt that has a number of characters (or number of words) less than a specified character length threshold or word length threshold. In some cases, when the prompt is too long, the distractor generation service may not be used to form MCQs.

Additionally, written questions employ the first side of a flashcard as a prompt, prompting users to provide a free response. The platform is programmed to utilize the second side as an answer to evaluate and grade the user's response.

In various cases, when user-generated content data is inputted into the learning system, it may be categorized into various content types. These content types can be manifested in different sets of flashcards, including concepts and definitions, practice questions and answers, raw notes, and similar materials. On occasion, both sides of a flashcard may serve as question prompts, while at other times, only one side, or even neither side (especially in instances where questions and answers are poorly formulated), may be deemed suitable for use as a question.

In various embodiments, when terms utilize user-generated content data for a flashcard, the learning system is configured to determine which side of the flashcard should be presented as a prompt to a user. This entails deciding which side of the flashcard serves as a “front” side or as a “prompt” side to be displayed for the user before displaying a “back” side or “response” side of the flashcard. In some cases, the first side of the flashcard may be presented as the prompt side. For instance, if the flashcard contains a concept that requires description, such as “The quantum entanglement” on the first side, it may be presented as the prompt side. Meanwhile, the corresponding response, such as “The phenomenon where two or more quantum particles become correlated in such a way that the state of one particle cannot be described independently of the state of the others, even when vast distances separate them,” located on the second side of the flashcard, can be presented as a response side, which the user can verify after completing the description of the concept.

Alternatively, the learning system may be configured to present the second side of the flashcard as the prompt side, depending on the specific wording or formulation of the question within the flashcard. For example, in the scenario mentioned earlier, the learning system might present the second side of the flashcard as the prompt side, describing “The phenomenon where two or more quantum particles become correlated in such a way that the state of one particle cannot be described independently of the state of the others, even when they are separated by vast distances.” Subsequently, “The quantum entanglement” would be presented as a response side.

In instances where both approaches (presenting the first side first or presenting the second side first) are viable, there may not be a preference. However, in certain cases, presenting the first side as the prompt side may be preferred or required. For example, if the first side includes a question prompt such as “Please select from the following list of choices an aquatic mammal having two extended tusks: A-deer, B-Great White, C-Antelope, D-Odobenus rosmarus, and E-Narwhal,” and the second side includes “Odobenus rosmarus or Walrus,” the learning system may be configured to present the first side of the flashcard as the prompt side. Presenting the second side as the prompt side would undermine the testing or learning process intended by the question design.

In certain instances, the second side of a flashcard may be presented first, contingent upon the flashcard's design. For instance, if the second side contains an answer such as “1861-1865,” while the first side poses the question “What are the dates for the American Civil War?”, it may be more advantageous to present the second side first. This approach prevents the student from being immediately directed to the correct answer, allowing for a more effective learning experience and encouraging deeper engagement with the material.

The decision on whether to present the first side or the second side of the flashcard as a prompt side is referred to here as a “study direction,” or SD. For example, the study direction can have a value of “1” or “Word”,” indicating that the first side needs to be presented as a prompt side, or a value of “2” or “Definition, indicating that the second side needs to be presented as a prompt side. It should be noted that such values are selected as a convention, and any suitable values can be chosen to indicate whether a first or the second side of the flashcard is selected. In some cases, a value of “0” may be used to indicate that none of the sides of the flashcard may be selected due to poor formulation of either question, an answer, or both for the flashcard. Alternatively, in some cases, a value of “1.5” may be selected, indicating that both the first and the second side of the flashcard may be selected as a prompt side with equal likelihood. In some cases, when it is determined that selecting a first side has a likelihood p₁ and selecting a second side has a likelihood p₂, the study direction SD may have a value of: SD=ƒ(p₁+2·p₂), where ƒ is a function that converts the value for SD into a definite selection of either “Word” or “Definition.” For example, function ƒ may map into “Word” when (p₁+2p₂)<1.5 and may map to “Definition” when (p₁+2p₂)>1.5. Alternatively, function ƒ may map into “Word” when (p₁+2p₂)≤1.5 and may map to “Definition” when (p₁+2p₂)>1.5.

TABLE 1 below presents examples of terms and their corresponding study directions:

TABLE 1

| Word | Definition | Study Direction |
|---|---|---|
| mitosis | part of eukaryotic cell | both |
| | division during which the | |
| | cell nucleus divides | |
| A sentence of imprisonment | 1 year | Word |
| for a Class “A” | | |
| misdemeanor is a definite | | |
| sentence which shall not | | |
| exceed | | |
| A. 6 months | | |
| B. 1 yr | | |
| C. 3 yrs | | |
| D. 7 yrs | | |
| Not true | A Z-score is an area under | definition |
| | the normal curve | |
| All of the following are a | 1-RM test | Neither |
| type of test to determine | | |
| VO 2max Except | | |

In various embodiments described herein, one or more computer programs implement a study direction prediction service designed to determine the study direction for a flashcard and/or a set of flashcards. The study direction prediction service is configured to receive input items, including terms of user-generated content, and utilizes a machine learning model to generate study direction prediction values. For instance, the machine learning model may be trained to take a flashcard as input and output a study direction value associated with the likelihood of using either the first or the second side of the flashcard as a prompt. Furthermore, the machine learning model may also provide other metadata associated with the flashcard. For example, the metadata may include an account-related identifier of a user who provided user-generated content data represented as one or more terms, a time and date when the user-generated content data was provided, a language of the one or more terms, a topic associated with the one or more terms, parameters such as the level of difficulty of the flashcard, the source or origin of the user-generated content data, any tags or keywords associated with the flashcard, the frequency of usage or interaction with the flashcard, as well as any feedback or ratings provided by users regarding the flashcard's effectiveness or accuracy.

In certain cases, such as within a distributed community environment, individuals without expertise in crafting effective study materials can contribute a plethora of study terms. The disclosed technology streamlines this process by automatically organizing these terms and facilitating interactive learning. It achieves this by determining predicted desired study direction values for various flashcards based on their content. Once these values are established, the flashcards can be accurately presented to users, ensuring that the appropriate side of each flashcard is displayed based on the determined study directions. this approach optimizes the effectiveness and efficiency of presenting study terms to other users.

### 2. Structural & Functional Overview

### 2.1 Distributed Computer System Example

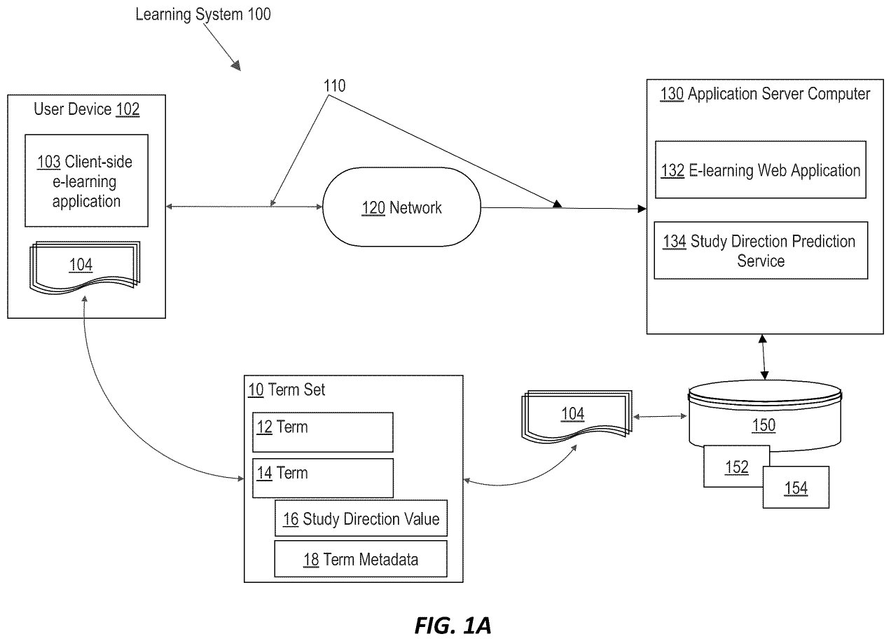

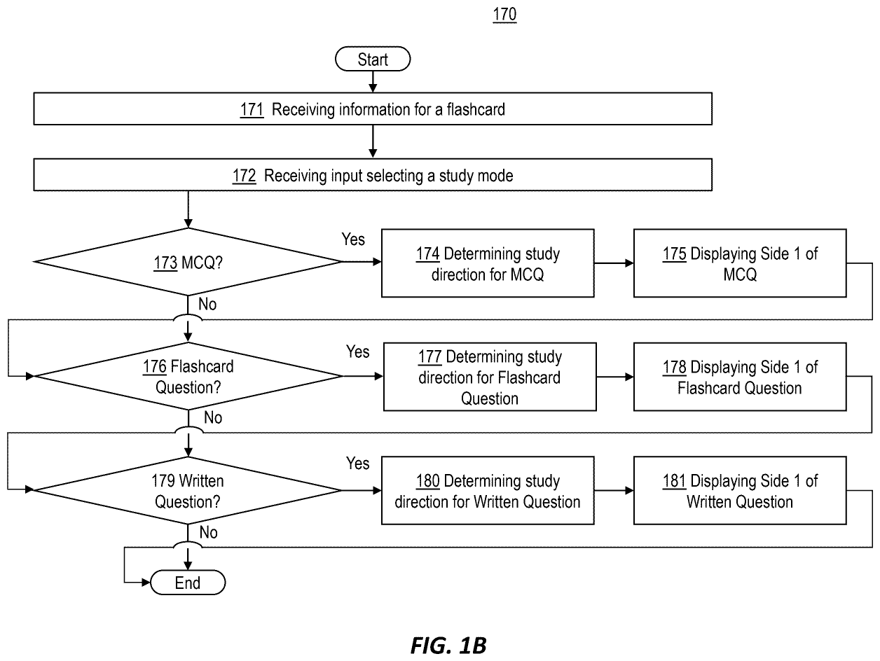

FIG. 1A illustrates a distributed computer system with which one or more embodiments can be implemented. As an example, the drawing figures show specific configurations of components, but other configurations may be used in other embodiments. For example, components of the drawing figures could be combined to create a single component, or the functions of a single component could be implemented using two or more components.

In an embodiment, a distributed computer system organized as a learning system 100 is configured to automatically generate predictions of one or more study directions for digitally stored terms that are associated with a term set. FIG. 1A, the other drawing figures, and all the descriptions and claims in this disclosure are intended to present, disclose, and claim a wholly technical system with wholly technical elements that implement technical methods. In the disclosure, specially programmed computers, using a special-purpose distributed computer system design, execute functions that have not been available before in a new manner using instructions ordered in a new way to provide a practical application of computing technology to the technical problem of accurately predicting the preferred study direction for an item of user-generated content (UGC), including but not limited to digitally stored representations of study terms. Every step or operation that is functionally described in the disclosure is intended for implementation using programmed instructions that are executed by a computer. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

Certain embodiments are described in the context of online, real-time response, automated e-learning systems. However, other embodiments can be used in domains other than education to generate predictions of directions for prompts, questions, or statements of a variety of types, and the scope of the disclosure is not limited to e-learning or education.

In one embodiment, the learning system 100 comprises a user device 102 that can be associated with a user of interest, such as a student, and is communicatively coupled using one or more telecommunication connections 110 and a network 120 to an application server computer 130. In an embodiment, the application server computer 130 is communicatively coupled to network 120 and to database 150, which can be programmed using a relational table schema to store a plurality of relational tables 152, 154. The user device 102 and application server computer 130 can interoperate to create, transmit, present, and receive response signals relating to digitally stored flashcards 104. Each of the flashcards 104 can be associated, in database table 152 of database 150, with digital data specifying terms 12 and 14 that are associated with a term set 10, where each of the terms 12 and 14 is associated with one or more study direction values 16 and term metadata 18.

In one embodiment, each of flashcards 104 includes two sides containing data records, with each side capable of displaying digital text data. In various cases, the data records associated with each of flashcards 104 are stored in memory and can be retrieved when displaying a flashcard. Furthermore, the data within these records may not be confined solely to text. It can also include a variety of multimedia formats. This includes images, video data, interactive content, audio data, multimedia presentations, 3D models, and the like. This versatility allows for a rich and dynamic learning experience catering to diverse learning styles and preferences.

In one embodiment, each flashcard 104 can comprise two sides of digitally stored text data, such as a word side text Qword, a definition side text Qdef, or both as a Qterm. Qterm can be a concatenation of a Qword and Qdef to combine the word side text and the definition side text of the flashcard 104. For example, in an embodiment, under the control of a client-side e-learning application 103, the user device 102 can signal a choice of a flashcard 104, which includes a question that can be characterized by a Qword, such as “What is a Nucleoid?” or “A nucleoid is a ______”, a Qdef, such as “in prokaryotes, it is where the cell's DNA is stored but it is not an enclosed organelle”, or a Qterm, such as “What is a Nucleoid? In prokaryotes it is where the cell's DNA is stored, but it is not an enclosed organelle.” Other embodiments can use a browser program on user device 102 to programmatically interoperate with an e-learning web application 132 hosted on the application server computer 130. While the foregoing presents an example of an online, real-time interaction between the user device 102 and the application server computer 130, certain embodiments also use offline, back-end, or batch processing under the control of the application server computer to transform records of the database 150 without interaction with user device 102, as further described in other sections herein.

For the purpose of illustrating a clear example, FIG. 1A shows a user device 102 and a flashcard 104 via a single logical connection 110, but other embodiments can use any number of user devices to create, read, and signal responses to flashcards. The present disclosure anticipates operation with thousands to millions of flashcards, having many associated term sets.

At application server computer 130, the e-learning web application 132 can comprise one or more sequences of stored program instructions that implement an HTTP server and business logic to execute e-learning functions such as creating student accounts, receiving data to specify schools and courses, determining one or more term sets, such as term set 10 that are relevant to courses in which student accounts are enrolled, presenting terms 12, 14, study direction value 16, and term metadata 18, evaluating response signals, transmitting answers, and otherwise managing an e-learning process.

The application server computer 130 further comprises, in one embodiment, a study direction prediction service 134, which can be implemented as sequences of stored instructions that are programmed to generate, using predictive algorithms based on executing the inference stage of a trained machine learning model, a study direction value 16 for association with an answer for a particular term 12, 14, using a plurality of programmed algorithms and machine learning models. In some embodiments, the study direction prediction service 134 comprises a microservice that the e-learning web application 132 or other services or applications can call programmatically. Further, in an embodiment, the study direction prediction service 134 can be programmed to execute as an offline, back-end, or batch job to access or read term sets, such as term set 10 containing terms 12, 14 successively to execute the plurality of algorithms and evaluate the machine learning models in Inference stages to generate predictions of one or more instances of a study direction value 16 with other metadata 18 and digitally store the predicted study direction values and metadata in one or more of the tables 152, 154, as further described.

In one embodiment, user device 102 may be a computer that includes hardware capable of communicatively coupling the device to the application server computer 130 over one or more service providers. For example, user device 102 may include a network card that communicates with application server computer 130 through a home or office wireless router (not illustrated in FIG. 1A) that is communicatively coupled to an internet service provider. The user device 102 may be a smartphone, personal computer, tablet computing device, PDA, laptop computer, or any other computing device capable of transmitting and receiving information and performing the functions described herein.

In one embodiment, the user device 102 may comprise device memory, an operating system, one or more application programs such as client-side e-learning application 103 and/or a browser, and/or one or more application extensions. In one embodiment, user device 102 hosts and executes the client-side e-learning application 103, which the user device 102 may download and install from application server computer 130, an application store, or another repository. The client-side e-learning application 103 is compatible with the e-learning web application 132. It may communicate using an app-specific protocol, parameterized HTTP POST and GET requests, and/or other programmatic calls. In some embodiments, client-side e-learning application 103 comprises a conventional internet browser application that can communicate over network 120 to other functional elements via HTTP and is capable of rendering dynamic or static HTML, XML, or other markup languages, including displaying text, images, accessing video windows and players, and so forth. In embodiments, application server computer 130 may provide an application extension for client-side e-learning application 103 through which the communication and other functionality may be implemented. In embodiments, a device display, such as a screen, may be coupled to the user device 102 to render a graphical user interface based on presentation instructions transmitted from the application server computer 130.

For example, the client-side e-learning application 103 may be programmed to provide a text input in a query as a question in a flashcard for a user of interest in a learning mode, also termed a learn mode or a learn function. As another example, the client-side e-learning application 103 may be programmed to receive a text input in a query by a user from the device display running on the user device 102. The text input can include a word side of the question, such as a Qword, or a definition side of the question, such as a Qdef, or both. The client-side e-learning application 103 may be programmed to send the received text input from the user device 102 in a query via network 120 to the application server computer 130 as text data. For example, the text input may be any text string comprising one or more unigrams. As used herein, unigrams may be determined from words or groups of words, any part of speech, punctuation marks (e.g., “%”), colloquialisms (e.g., “move forward”), acronyms (e.g., “MCQ”), abbreviations (e.g., “ct.”), exclamations (“ugh”), alphanumeric characters, symbols, written characters, accent marks, or any combination thereof. As another example, the text input may be an input Qword of “What is a Nucleoid?” which includes multiple unigrams, such as “What”, “is”, “a”, “Nucleoid”, and “?”.

The application server computer 130 may be implemented using a server-class computer or other computer having one or more processor cores, co-processors, or other computers. The application server computer 130 may be a physical server computer and/or one or more virtual machine instances and/or virtual storage instances hosted or executed in a private or public data center, such as through a cloud computing service or facility. In one embodiment, an application server computer may be implemented using two or more processor cores, clusters, or instances of physical machines or virtual machines, configured in a discrete location or co-located with other elements in a data center, shared computing facility, or cloud computing facility.

Each of the functional components of the learning system 100 can be implemented as one or more sequences of stored program instructions stored in non-transitory computer-readable storage media, other software components, general or specific-purpose hardware components, firmware components, or any combination thereof. A storage component, such as database 150, can be implemented using any of relational databases, object databases, flat file systems, or JSON stores. A storage component like database 150 can be connected to the functional components locally or through the networks using programmatic calls, remote procedure call (RPC) facilities, or a messaging bus. A component may or may not be self-contained. Depending upon implementation-specific or other considerations, the components may be centralized or distributed functionally or physically.

As further described in detail in other sections, study direction prediction service 134 is programmed or configured to automatically generate predictions of study direction values 16 and metadata 18 based on receiving candidate terms as input. To do so, study direction prediction service 134 executes the inference stage of a trained machine learning model, which can be hosted at application server computer 130 over the input. Embodiments of machine learning models, heuristic algorithms, rule-based algorithms, and other means of automated machine decision-making are described further in other sections below.

### 2.2 Method of Displaying Flashcards

FIG. 1B illustrates an example method 170 for displaying information on a flashcard. This display can vary among a Multiple-Choice Question (MCQ) type, a Flashcard Question type, or a Written Question type, depending on the study mode selected, such as “learn,” “test,” or “flashcard” mode. The content of the flashcard can be formatted in any suitable manner. For example, information for the flashcard may be formatted using a JSON which can be written, for example, as:

```
{
  “Question”: “What is the capital of France?”,
  “Answer”: “Paris”
}
```

Alternatively, the information on a flashcard can be formatted in any suitable manner that clearly demarcates the question and answer fields. For example, the flashcard content might be presented in a table format, with the first field corresponding to the question and the second field corresponding to the answer.

When presenting a flashcard to a user in any suitable mode, such as MCQ, Flashcard Question, or Written Question, the question is typically displayed on the first side of the flashcard, and the answer can optionally be displayed on the second side. The format of the question and answer may be adjusted to suit the specific type of flashcard being used. For instance, when displaying an MCQ-type flashcard, additional multiple-choice answers can be generated through a distractor generation service, as previously described. Conversely, for a Written Question type flashcard, the answer might not be displayed; instead, a field for entering the answer could be provided on the second side of the flashcard.

Method 170 involves, at step 171, receiving information for the flashcard. For example, at step 171, the information for the flashcard may include information regarding a particular topic or subject, from which a flashcard will be formed. Method 170 further involves, at step 172, receiving an input from a user that determines the study mode, such as “learn,” “test,” or “flashcard” mode. For example, the input may be a user input (e.g., cursor click, touch input, etc.). The selected study mode influences how the flashcard is presented. For instance, in “learn” mode, the flashcard information may be presented as a Multiple-Choice Question (MCQ), whereas in “test” mode, it could be presented as either an MCQ or a Written Question. Additionally, in “flashcard” mode, the information may be displayed as a Flashcard Question. This flexibility allows the presentation format to be tailored to the learning context. When a user selects the study mode, they are presented with mode setting options to select the question types they want to be tested with. For instance, in “learn” mode, the question options presented to the user can include “MCQ”, “Written”, or “Flashcard”. If the user does not make a selection, a default question may be an “MCQ” or a “Written” question. Both the selection of the study mode and the setting options for the study mode influence how the flashcard is presented.

Method 170 includes several decision points based on the type of presentation required for the flashcard. At conditional step 173, if the flashcard needs to be presented as an MCQ, the method proceeds to step 174 to determine the appropriate study direction for the MCQ flashcard. The study direction for the MCQ flashcard is determined using approaches described herein. Following this, at step 175, the MCQ flashcard is displayed to the user.

If the information does not need to be presented as an MCQ flashcard (step 173, No), method 170 advances to conditional step 176 to assess whether it should be presented as a Flashcard Question. Also, method 170 is configured to advance to conditional step 176 after completion of step 175. If affirmative (step 176, Yes), method 170 then proceeds to step 177 to determine the study direction for the Flashcard Question flashcard. The study direction for the Flashcard Question flashcard is determined using approaches described herein. After determining the study direction, method 170 continues to step 178 where the Flashcard Question flashcard is displayed to the user.

If the information is not required as a Flashcard Question (step 176, No), method 170 progresses to conditional step 179 to evaluate if it should be presented as a Written Question. Also, method 170 is configured to advance to conditional step 179 after completion of step 178. If affirmative (step 179, Yes), method 170 moves to step 180 to establish the study direction for the Written Question flashcard. The study direction for the Written Question flashcard is determined using approaches described herein. Subsequently, at step 181, the Written Question flashcard is displayed to the user. Alternatively, if Written Question flashcard should not be presented (step 179, No), method 170 terminates. Additionally, the method terminates after the completion of step 181.

### 2.3 Example Data Processing Flows

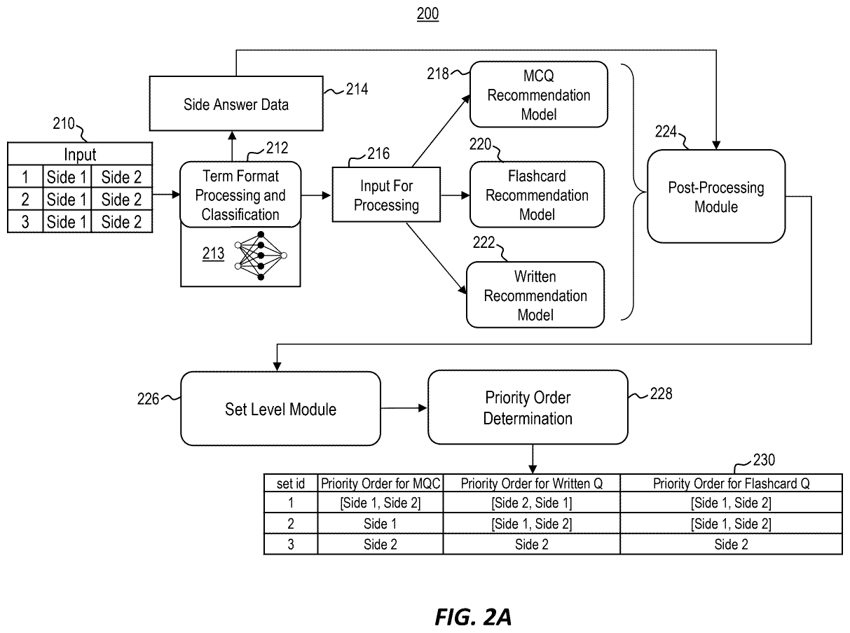

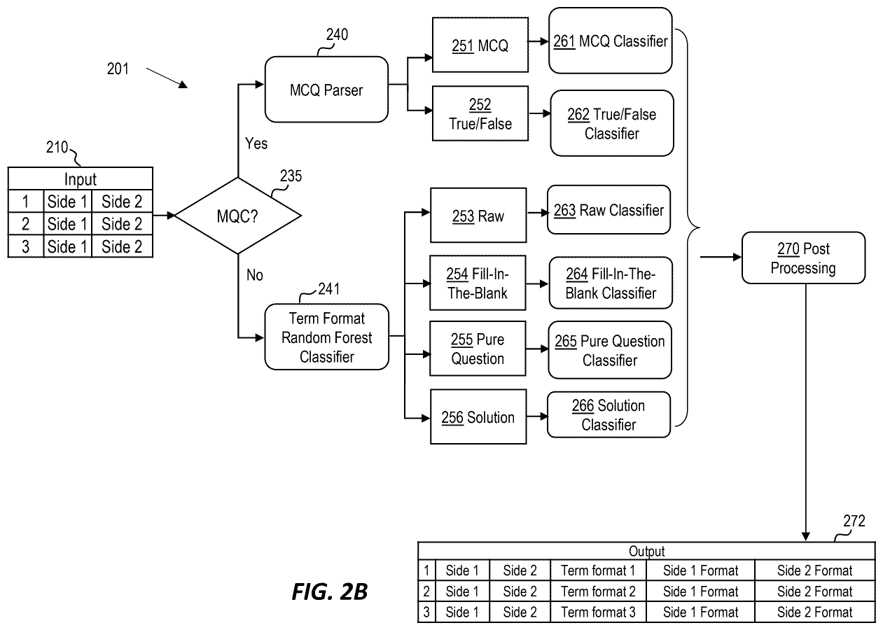

FIG. 2A and FIG. 2B show diagrams of illustrative processes of determining study directions for different terms represented by flashcards. The views of FIG. 2A and FIG. 2B are intended to illustrate the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

One embodiment provides a Machine Learning (ML) Study Direction service implemented in software that optimizes the study direction of user-generated content data terms, such as digitally stored and presented study flashcards, in multiple Study Modes for the desirable study experience. To improve study experiences and boost engagement, in an embodiment, an ML-based service is programmed to recommend the desirable study direction tailored to the content of terms and sets. This service powers study modes of the platform, ensuring questions are asked from the most logical side based on the question type and content.

FIG. 2A illustrates an example process in a diagram 200 of determining study direction through the utilization of machine learning models configured to analyze data from terms represented as flashcards. Besides employing machine learning models, various other data processing models may also be utilized. For instance, some data processing models may incorporate text processing models tailored to identify patterns within text, utilizing methods such as regular expressions.

In certain cases, specific patterns within the data may be sought based on anticipated patterns commonly observed within datasets containing flashcards. For example, if a flashcard includes multiple choice questions, patterns related to a list of multiple choices could be identified. A pattern such as “\([A-Z]\) [\hat{ }\n]+” may be employed to recognize multiple choice questions, which can include text such as “(A) Walrus” or “(B) Narwhal.” Such a pattern can match strings that start with a single uppercase letter enclosed within parentheses, followed by a space, and then followed by one or more characters other than a newline. The aforementioned pattern serves as just one illustrative example among many, and various other patterns may be identified using techniques such as regular expressions or any other suitable techniques for data processing.

Diagram 200 includes several data processing models organized in a workflow pipeline configured to process data and determine a study direction for one or more flashcards. In an example embodiment, shown in diagram 200, an input 210 can be provided to a term format processing and classification module 212. Input 210 may include data representing a set of flashcards (e.g., three flashcards as shown in FIG. 2A), with each flashcard having a first data record associated with a first side (Side 1) and a second data record associated with a second side (Side 2).

Term format processing and classification module 212 is configured to process input 210 and to classify various flashcards in input 210 by their type. During the processing of a flashcard, term format processing and classification module 212 may be configured to extract a first data record from the first side of the flashcard and a second data record from the second side of the flashcard and store these data records in a memory for further processing. When processing the first and the second data records, text data associated with these data records may be extracted and preprocessed. The preprocessing may help standardize and clean text data for further analysis. The preprocessing can include tokenization, which involves breaking the text into smaller units such as words, phrases, or sentences. Lowercase conversion may be performed following tokenization to ensure consistency in word representation by converting all text to lowercase. Removing punctuation marks may also be done when preprocessing text data. Similarly, words such as “the,” “is,” and “and”—are filtered out as they carry little semantic meaning. Further, special characters, numbers, HTML tags, and URLs may be removed or replaced with placeholders to prevent them from interfering with text analysis. Additionally, handling contractions by expanding them to their full forms and correcting spelling mistakes can improve the quality of the text data.

By applying such preprocessing techniques, text data becomes standardized, cleaner, and more suitable for various data analysis tasks, such as flashcard classification. The specific preprocessing steps employed may vary depending on the nature of the text data.

Additionally, during the preprocessing, term format processing and classification module 212 may determine which side of a flashcard contains no answer. For example, if the flashcard side contains a question, “What were the characteristics of the Yahwist tradition?” such side is determined not to contain an answer. Such determination can be made, for example, by detecting a question mark at the end of the sentence. In some cases, to determine whether a side may or may not contain an answer, term format processing and classification module 212 may employ a rule-based analysis, which can include, among other things: determining if the side includes a multiple choice question prompt; includes a question prompt; or exceeds a predetermined text length threshold.

In some cases, to determine whether a side of a flashcard includes a question or an answer, a heuristic approach may be used, which can include analyzing a set of flashcards. If several flashcards include sides that are identical (or similar) such sides may be determined not to contain an answer. For example, if two flashcards include at the first side a prompt “Name the largest planet in our Solar System” the first flashcard includes at the second side an answer “Jupiter” while the second flashcard includes at the second side an answer “Saturn,” both sides can be considered correct because Jupiter is the largest planet by volume and Saturn is the largest planet by mass. Thus, considering that both flashcards have a duplicate prompt “Name the largest planet in our Solar System,” such prompt (due to its duplicity between two or more flashcards) may not be considered an answer. Upon determining whether a side does not contain an answer, a flag identifying the side that contains no answer may be determined and presented as data denoted side answer data 214. Such data can later be used to determine the study direction. In some cases, side answer data 214 may be presented as a likelihood tuple as {Side 1, p₁}, indicating that Side 1 does not contain the answer with the probability of p₁.

Furthermore, term format processing and classification module 212 may also determine during the preprocessing whether the flashcard includes suitable questions and answers or if the flashcard cannot be easily answerable or cannot be used effectively for learning. For example, a flashcard that cannot be used for learning may contain unintelligible text data on both sides of the flashcard (or at least on one side of the flashcard), making the flashcard incomprehensible. Such incomprehensible text may be determined by identifying the combination of letters that do not match any known words. In some cases, unintelligible text data can be determined using grammar checking or rule-based parsing. For instance, rule-based parsing may be used to break down the sentence into its constituent parts (e.g., subject, verb, object) and check for syntactic correctness.

Term format processing and classification module 212 is configured to determine a type of a question that is represented by each flashcard in input 210. Among various types of flashcards, there can be a multiple choice question (MCQ) flashcard, a Pure Question, a Fill-In-The-Blank (FITB), a Raw, or a Solution. It should be noted that in some cases other types of flashcards may be used, or a flashcard may include multiple questions that may combine different types of flashcards into a single flashcard.

An example MCQ flashcard may include a question at the first side and an answer at the second side of the flashcard. For instance, an MCQ flashcard may include on a first side (Side 1) “On this side of the flashcard, when looking at an image, you see: (A) A narwhal, (B) A walrus, (C) A multiple choice question,” and on a second side (Side 2) an answer: “(B)”.

In some cases, MCQ flashcard may be a True/False binary choice question. For example, such flashcards may display on the first side, “This statement is false. True or False?” and on the second side, “False.”

An example Pure Question flashcard may include on the first side, “What is the capital of France?” and the second side, “Paris.” Another example Pure Question flashcard may include on the first side of the flashcard, “What is the chemical symbol for water?” and on the second side, “H2O.” It should be noted that Pure Question flashcards are not limited to individual words but can be used to identify terms that may be represented by several words and/or event phrases. An example Pure Question flashcard may include on the first side, “What is the medical term for the condition characterized by an accumulation of cerebrospinal fluid within the brain's ventricles, but with normal pressure?” and at the second side, “normal pressure hydrocephalus.”

An example Fill-In-The-Blank flashcard includes on the first side, “The ______ is the largest planet in our solar system,” and on the second side, “Jupiter.”

Raw flashcards are not designed with obvious question prompts and fall under a catch-all category used when a term cannot be classified into other question types. For instance, a typical Raw flashcard might look like this:

| Side 1 | Side 2 |
|---|---|
| Services which provide assistance in | personal care support. |
| performing daily living activities such as | |
| bathing, dressing, grooming and going to the | |
| toilet. | |

An example of a Solution Flashcard represents a type of incomplete flashcard that features an MCQ prompt and an answer but lacks options. For instance, the first side might state, “All of the following are types of tests to determine VO2max EXCEPT:” and the second side includes “1-RM test.” Note that the first side does not specify what the “following” items are. These types of flashcards are called Solution Flashcards, hypothesized to be designed for cheating purposes.

In various embodiments, besides classifying a flashcard as MCQ/True-False, Pure Question, or Fill-In-The-Blank Question, or Solution, or Raw, a classification for each side of a flashcard may be determined. Such classification for a side may include a “question” side, an “answer” side, a “long” side, and a “short” side. For instance, for RAW flashcards, one side may be “long,” while another may be “short,” and for all other types of flashcards, one side may be a “question,” and another side may be an “answer.”

Term format processing and classification module 212 can use various approaches for determining the classification for flashcards within input 210. In one approach, as mentioned before, a regex-based MCQ parser may be used to determine if a term in a flashcard is an MCQ. For instance, a pattern such as “\([A-Z]\) [\hat{ }\n]+” and/or “\ ([a-z]\) [\hat{ }\n]+” may be employed to recognize multiple choice questions. Other patterns may include “\hat{ }\d+\.[\hat{ }\?\.]*[\?\.],” or various other patterns.

Additionally, or alternatively, term format processing and classification module 212 includes a trained MLM 213 for determining the classification of a flashcard. MLM 213 may be trained using labeled examples where at least some training text data identifies multiple choice questions and other data does not. In some cases, MLM 213 may be a logistic regression model, which may work well for structured text data. Alternatively, a Support Vector Machine (SVM) may also be used. For more robust classification, random forests can be used as the trained MLM. These models combine multiple decision trees for improved accuracy. Furthermore, in some cases, Recurrent Neural Networks (RNNs) or NPL MLMs might be used. The RNNs and NPL MLMs excel at capturing sequential information in text, making them potentially well-suited for handling text with multiple choice questions.

In an example implementation, when training MLM 213, a large sample of tens, hundreds, thousands, or tens of thousands of flashcards may be used. Each flashcard in the training sample may be classified as a particular type (e.g., MCQ, RAW, Solution, Pure Question, etc.). Subsequently, the training sample can be used for determining a type of the flashcard. In one particular implementation, MLM 213 may be a random forest classifier that is configured to take features extracted from text data corresponding to a flashcard and classify the flashcard as MCQ, RAW, Solution, Pure Question, Fill-In-The-Blank Question, and the like. A Suitable random forest model may be selected from available libraries such as, for example, scikit-learn (Python) or R packages like randomForest. After selecting a model template, a particular model may be defined. For instance, parameters such as the number of trees in the forest and the maximum depth of each tree, may be specified. Prior to training the model, features from text data representing a term shown in a flashcard may be extracted using any suitable ways. For example, features may be extracted by utilizing word embeddings (e.g., using GloVe embeddings, Word2Vec embeddings, etc.), thereby incorporating semantic relations between the words in the text. The word embeddings for multiple words of the text data may then be combined in any suitable way (e.g., concatenated) to form an input for the Random Forest for the classification.

Additionally, or alternatively, a suitable RNN such as Long Short-Term Memory (LSTM) network (or similar network such as Bidirectional LSTM) which can process a sequence of embedding vectors representing the text data can be used. It can be trained based on the classification labels denoting classifications for the flashcards. In some cases, results from LSTM and Random Forest may be combined to obtain a more accurate prediction for classifying flashcards.

In addition, for performing a classification for flashcards, term format processing and classification module 212 may also be configured to generate a list of flashcard features derived from the terms, the flashcard features described by the following parameters summarized in a TABLE 2 below. For convenience, the leftmost column corresponds to a feature number.

TABLE 2

| | Flashcard Feature | Explanation of Flashcard Features |
|---|---|---|
| 1 | is_translation | True if one side of a flashcard is a translation |
| | | of another (False otherwise). In this disclosure, |
| | | value “1” can be used to denote True value and |
| | | “0” can be used to denote False value |
| 2 | term_format | Classification of a flashcard (e.g., MCQ, RAW, |
| | | etc.) |
| 3 | prompt_has_bullet | True if the side of a flashcard to be used as the |
| | | prompt side has one or more bullets |
| 4 | prompted_with_{—} | True if the side of a flashcard to be used as the |
| | wrong_side | answer side contains question prompt |
| 5 | both_sides_have_{—} | True if both sides of a flashcard have question |
| | question_mark | mark (False otherwise) |
| 6 | both_sides_have_{—} | True if both sides of a flashcard are blank |
| | blank | (False otherwise) |
| 7 | answer_has_bullet | True if the side of a flashcard to be used as the |
| | | answer side has one or more bullets (False |
| | | otherwise) |
| 8 | answer_has_list_{—} | True if the side of a flashcard to be used as the |
| | words | answer side has a list of words (False |
| | | otherwise) |
| 9 | answer_token_{—} | Evaluates to a number of tokens for the side of |
| | count | a flashcard to be used as the answer side. |
| | | Tokens are obtained by breaking a text into |
| | | smaller units (tokens). Tokens may correspond |
| | | to individual words of the text |
| 10 | answer_special_{—} | Determines a ratio of a number of special |
| | character_by_{—} | characters to tokens in the text of the side of a |
| | token_ratio | flashcard to be used as the answer side |
| 11 | answer_has_{—} | Evaluates to True if text of the side of a |
| | number | flashcard to be used as the answer side contains |
| | | a number |

A TABLE 3 below shows examples of different terms labeled with (0) or (1) with corresponding values for the different features 1 through 11 shown in the left column of Table 2. Label (0) indicates that a side 1 is selected as a prompt side to be shown to a user, and label 1 indicates that a side 2 of a flashcard is selected as a prompt side to be shown to a user.

TABLE 3

| | | Flashcard Features |
|---|---|---|
| Label, and prompt | Answer | {1, 2, 3, 4, 5, 6, 7, 8, 9, 10, 11} |
| (0) makes the serous | lateral mesoderm | {0 fitb 0 0 0 0 0 0 2 0 |
| membranes of pleura | | 0} |
| (0) va | han, hon, går/åker | {1 raw 0 0 0 0 0 1 4 |
| | | 0.5 0} |
| (0) Prezygotic, Mechanical | Isolation based on lack of fit | {0 raw 0 0 0 0 0 0 48 |
| | between sex organs. | 0.0833 0} |
| | Example: Damselflies | |
| | (Damselfly reproductive | |
| | organs come in various sizes | |
| | and shapes depending on their | |
| | species) | |
| | Gametes of separate species | |
| | will never meet, and hybrid | |
| | offspring will never be created | |
| | since they can only physically | |
| | mate with their own species. | |
| (0) what was established in | Social security | {0 pure_question 0 0 0 |
| 1935 to provide monetary | | 0 0 0 2 0 0} |
| benefits to older retired | | |
| workers to prevent or | | |
| minimize their dependency | | |
| on younger members of | | |
| society? | | |
| (0) An engine-driven | Does | {0 fitb 0 000001 |
| constant-displacement | | 0 0} |
| pump | | |
| (does or does not) require | | |
| some type of valve to | | |
| unload the pump when no | | |
| component in the system is | | |
| actuated. | | |
| (0) Each fiber is | myofibrils, which have | {0 raw 0 0 0 0 0 0 8 |
| subdivided into | characteristic cross striations | 0.5 0} |
| | (Z line). | |
| (0) A 62-year-old smoker | C) Epistaxis | {0 mcq 1 0 0 0 0 0 2 |
| complains of “coughing up | | 0.5 0} |
| small amounts of blood,” | | |
| so you consider | | |
| hemoptysis. Which of the | | |
| following should you also | | |
| consider? | | |
| A) Intestinal bleeding | | |
| B) Hematoma of the nasal | | |
| septum | | |
| C) Epistaxis | | |
| D) Bruising of the tongue | | |
| (1) Schemas | Concepts or mental | {0 raw 0 0 0 0 0 0 9 |
| | frameworks that organize and | 0.1111 0} |
| | interpret information. | |
| (0) when parking a vehicle | toward the curb | {0 pure_question 0 0 0 |
| facing downhill, turn your | | 0 0 0 3 0 0} |
| wheels . . . | | |
| (1) Jelaskan rute | Spanyol □ Amerika Selatan □ | {0 raw 0 0 0 0 0 0 8 |
| Magelhaens | Fillipina □ Maluku | 1.125 0} |

Furthermore, in some cases, term format processing and classification module 212 may also be configured to generate an additional list of features, as summarized in TABLE 4 below.

TABLE 4

| Additional Flashcard Features | Explanation of Flashcard Features |
|---|---|
| lang_side1 | Language of the side 1 of a flashcard |
| lang_side2 | Language of the side 2 of a flashcard |
| word_has_question_prompt | Word side (side 1) has question (True/False) |
| definition_has_question_prompt | Definition side (side 2) has question |
| | (True/False) |
| word_is_duplicated | Text on side 1 of a flashcard is similar or |
| | duplicated on side 1 of another flashcard. |
| Definition_is_duplicated | Text on side 2 of a flashcard is similar or |
| | duplicated on side 2 of another flashcard. |
| Both_sides_are_duplicated | Both sides of a flashcard are duplicated to |
| | those of another flashcard |
| word_unanswerable_for_mcq | Text on side 1 of a flashcard is considered |
| | unanswerable when the flashcard is |
| | displayed in the MCQ question type in study |
| | modes. |
| definition_unanswerable_for_mcq | Text on side 2 of a flashcard is considered |
| | unanswerable when the flashcard is |
| | displayed in the MCQ question type in study |
| | modes |
| word_unanswerable_for_written | Text on side 1 of a flashcard is considered |
| | unanswerable when the flashcard is |
| | displayed in the Written question type in |
| | study modes |
| definition_unanswerable_for_written | Text on side 2 of a flashcard is considered |
| | unanswerable when the flashcard is |
| | displayed in the Written question type in |
| | study modes |
| word_unanswerable_for_flashcard | Text on side 1 of a flashcard is considered |
| | unanswerable when the flashcard is |
| | displayed in the Flashcard question type in |
| | study modes |
| definition_unanswerable_for_flashcard | Text on side 2 of a flashcard is considered |
| | unanswerable when the flashcard is |
| | displayed in the Flashcard question type in |
| | study modes |
| rec_mcq_for_word_side | True if the side 1 is recommended by the |
| | MCQ recommendation model (e.g., model |
| | 218 shown in FIG. 2A) to be used as the |
| | answer side for the MCQ question type in |
| | study modes, otherwise False. |
| rec_mcq_for_word_side_likelihood | Propensity score from the MCQ |
| | recommendation model (e.g., model 218 |
| | shown in FIG. 2A) trained by using features |
| | in Table 2 whether the side 1 should be used |
| | as the answer side for the MCQ question |
| | type in study modes. |
| Rec_mcq_for_definition_side | True if the side 2 is recommended by the |
| | MCQ recommendation model (e.g., model |
| | 218 shown in FIG. 2A) trained by using |
| | features in Table 2 to be used as the answer |
| | side for the MCQ question type in study |
| | modes, otherwise False. |
| rec_mcq_for_definition_side_likelihood | Propensity score from the MCQ |
| | recommendation model (e.g., model 218 |
| | shown in FIG. 2A) trained by using features |
| | in Table 2 whether the side 1 should be used |
| | as the answer side for the MCQ question |
| | type in study modes. |
| Mcq_set_level_preferred_answer_side | The response side of a flashcard for which |
| | the set-level preference for a study direction |
| | is determined for the MCQ question type in |
| | study modes |
| mcq_answer_side_priority_order | The side priority order for the MCQ |
| | question type in study modes |
| rec_written_for_word_side | True if the side 1 is recommended by the |
| | Written recommendation model (e.g., model |
| | 222 shown in FIG. 2A) to be used as the |
| | answer side for the Written question type in |
| | study modes, otherwise False. |
| rec_written_for_word_side_likelihood | Propensity score from the Written |
| | recommendation model (e.g., model 222 |
| | shown in FIG. 2A) whether the side 1 should |
| | be used as the answer side for the Written |
| | question type in study modes. |
| rec_written_for_definition_side | True if the side 2 is recommended by the |
| | Written recommendation model (e.g., model |
| | 222 shown in FIG. 2A) to be used as the |
| | answer side for the Written question type in |
| | study modes, otherwise False. |
| rec_written_for_definition_side_likelihood | Likelihood that th Propensity score from the |
| | Written recommendation model (e.g., model |
| | 222 shown in FIG. 2A) for whether the side 1 |
| | should be used as the answer side for the |
| | Written question type in study modes. |
| written_set_level_preferred_answer_side | The response side of a flashcard for which |
| | the set-level preference for a study direction |
| | is determined for the Written Question type |
| | in study modes |
| written_answer_side_priority_order | The side priority order for the Written |
| | Question type in study modes |
| rec_flashcard_for_word_side | True if the side 1 is recommended by the |
| | Flashcard recommendation model (e.g., |
| | model 220 as shown in FIG. 2A) to be used as |
| | the answer side for the Flashcard question |
| | type in study modes, otherwise False. |
| rec_flashcard_for_word_side_likelihood | Propensity score from the Flashcard |
| | recommendation model (e.g., model 220 as |
| | shown in FIG. 2A) for whether the side 1 |
| | should be used as the answer side for the |
| | Flashcard question type in study modes. |
| rec_flashcard_for_definition_side | True if the side 2 is recommended by the |
| | Flashcard recommendation model (e.g., |
| | model 220 as shown in FIG. 2A) to be used as |
| | the answer side for the Flashcard question |
| | type in study modes, otherwise False. |
| rec_flashcard_for_definition_side_likelihood | Propensity score from the Flashcard |
| | recommendation model (e.g., model 220 as |
| | shown in FIG. 2A) for whether the side 2 |
| | should be used as the answer side for the |
| | Flashcard question type in study modes. |
| flashcard_set_level_preferred_answer_side | The response side of a flashcard for which |
| | the set-level preference for a study direction |
| | is determined for the Flashcard Question |
| | type in study modes |
| flashcard_answer_side_priority_order | The side priority order for the Flashcard |
| | Question type in study modes |

Examples of output of different features for a few flashcards is shown in TABLE 5 and TABLE 6 below.

TABLE 5

| Flashcard Features and Parameters | Flashcard 1 | Flashcard 2 | Flashcard 3 |
|---|---|---|---|
| set_id | Term 1 | Term 2 | Term 3 |
| term_id | ID1 | ID2 | ID3 |
| side1 | sea fog | skip | germ line |
| side2 | What type | The | Mutations must |
| | of fog | instruction includes | occur in the |
| | occurs when | an implied address. | cells |
| | wind heated | a. skip | that produce |
| | by warm | b. rotate | either eggs or |
| | ocean water | c. stack | sperm. |
| | blows over | d. push | |
| | cool ocean | | |
| | water? | | |
| Lang_side1 | en | en | en |
| lang_side2 | en | en | en |
| word_has_question_prompt | FALSE | FALSE | FALSE |
| definition_has_question_prompt | TRUE | TRUE | TRUE |
| word_is_duplicated | FALSE | FALSE | FALSE |
| definition_is_duplicated | FALSE | FALSE | FALSE |
| both_sides_are_duplicated | FALSE | FALSE | FALSE |
| word_unanswerable_for_mcq | FALSE | FALSE | FALSE |
| definition_unanswerable_for_mcq | TRUE | TRUE | TRUE |
| word_unanswerable_for_written | FALSE | TRUE | FALSE |
| definition_unanswerable_for_written | TRUE | TRUE | TRUE |
| word_unanswerable_for_flashcard | FALSE | FALSE | FALSE |
| definition_unanswerable_for_flashcard | TRUE | TRUE | TRUE |
| rec_mcq_for_word_side | TRUE | TRUE | TRUE |
| rec_mcq_for_word_side_likelihood | 0.951353834 | 0 | 0.950406487 |
| rec_mcq_for_definition_side | FALSE | FALSE | FALSE |
| rec_mcq_for_definition_side_likelihood | 0 | 0 | 0 |
| mcq_set_level_preferred_answer_side | word | word | word |
| mcq_answer_side_priority_order | [‘word’] | [‘word’] | [‘word’] |
| rec_written_for_word_side | TRUE | FALSE | TRUE |
| rec_written_for_word_side_likelihood | 1 | 0 | 1 |
| rec_written_for_definition_side | FALSE | FALSE | FALSE |
| rec_written_for_definition_side_likelihood | 0 | 0 | 0 |
| written_set_level_preferred_answer_side | word | word | word |
| written_answer_side_priority_order | [‘word’] | [ ] | [‘word’] |
| rec_flashcard_for_word_side | TRUE | FALSE | TRUE |
| rec_flashcard_for_word_side_likelihood | 1 | 0 | 1 |
| rec_flashcard_for_definition_side | FALSE | FALSE | FALSE |
| rec_flashcard_for_definition_side_likelihood | 0 | 0 | 0 |
| flashcard_set_level_preferred_answer_side | word | word | word |
| flashcard_answer_side_priority_order | [‘word’] | [‘word’] | [‘word’] |

TABLE 6

| Flashcard Features and Parameters | Flashcard 4 | Flashcard 5 | Flashcard 6 |
|---|---|---|---|
| set_id | Term 4 | Term 5 | Term 6 |
| term_id | ID4 | ID5 | ID6 |
| side1 | The clearest | The clearest | decrease the |
| | liberalizing | liberalizing | velocity of |
| | influence on | influence | blood flow |
| | individuals | | |
| | comes from | | |
| side2 | higher | higher | increased |
| | education | education | viscosity |
| lang_side1 | en | en | en |
| lang_side2 | en | en | en |
| word_has_question_prompt | FALSE | FALSE | FALSE |
| definition_has_question_prompt | FALSE | FALSE | FALSE |
| word_is_duplicated | FALSE | FALSE | FALSE |
| definition_is_duplicated | TRUE | TRUE | FALSE |
| both_sides_are_duplicated | FALSE | FALSE | FALSE |
| word_unanswerable_for_mcq | TRUE | TRUE | FALSE |
| definition_unanswerable_for_mcq | FALSE | FALSE | FALSE |
| word_unanswerable_for_written | TRUE | TRUE | FALSE |
| definition_unanswerable_for_written | FALSE | FALSE | FALSE |
| word_unanswerable_for_flashcard | TRUE | TRUE | FALSE |
| definition_unanswerable_for_flashcard | FALSE | FALSE | FALSE |
| rec_mcq_for_word_side | FALSE | FALSE | TRUE |
| rec_mcq_for_word_side_likelihood | 0 | 0 | 0.918752959 |
| rec_mcq_for_definition_side | TRUE | TRUE | TRUE |
| rec_mcq_for_definition_side_likelihood | 0.951745876 | 0.951745876 | 0.951745876 |
| mcq_set_level_preferred_answer_side | definition | definition | word |
| mcq_answer_side_priority_order | [‘definition’] | [‘definition’] | [‘word’, |
| | | | ‘definition’] |
| rec_written_for_word_side | FALSE | FALSE | TRUE |
| rec_written_for_word_side_likelihood | 0 | 0 | 1 |
| rec_written_for_definition_side | TRUE | TRUE | TRUE |
| rec_written_for_definition_side_likelihood | 1 | 1 | 1 |
| written_set_level_preferred_answer_side | definition | definition | word |
| written_answer_side_priority_order | [‘definition’] | [‘definition’] | [‘word’, |
| | | | ‘definition’] |
| rec_flashcard_for_word_side | FALSE | FALSE | TRUE |
| rec_flashcard_for_word_side_likelihood | 0 | 0 | 1 |
| rec_flashcard_for_definition_side | TRUE | TRUE | TRUE |
| rec_flashcard_for_definition_side_likelihood | 1 | 1 | 1 |
| flashcard_set_level_preferred_answer_side | definition | definition | definition |
| flashcard_answer_side_priority_order | [‘definition’] | [‘definition’] | [‘definition’, |
| | | | ‘word’] |

After the flashcards from input 210 are classified using term format processing and classification module 212, the classification information and text data extracted from these terms (shown as input for processing 216 in FIG. 2A) are submitted to an appropriate recommendation model. Depending on the desired output, this could be MCQ recommendation model 218 for generating multiple choice questions, flashcard recommendation model 220 for generating additional flashcards, or written recommendation model 222 for generating written explanations or summaries. MCQ recommendation model 218 is configured to recommend a study direction when the MCQ Question type is chosen to show the flashcards in the study modes, flashcard recommendation model 220 is configured to recommend a study direction when the Flashcard Question type is chosen to show the flashcards in study modes, and written recommendation model 222 is configured to recommend a study direction when the Written Question type is chosen to show the flashcards in study modes, as described above.

Table 7 shows examples of term format and side format predictions.

TABLE 7

| | | | | predicted | predicted |
|---|---|---|---|---|---|
| | | | predicted | word | definition |
| | | | term | side | side |
| Side 1 | Side 2 | label | format | format | format |
| This is two period American | A, B | 1 | Pure | question | answer |
| put option with 2 years | | | Question | | |
| maturity. Underlying asset | | | | | |
| price at current time is $100 | | | | | |
| and u(up factor in the | | | | | |
| binomial tree) is 1.05 and | | | | | |
| d(down factor in the binomial | | | | | |
| tree) is 0.95. The exercise | | | | | |
| price is $100 and risk free | | | | | |
| rate is 1%. | | | | | |
| What is the put option price at | | | | | |
| current time? | | | | | |
| A) $2.04 | | | | | |
| B) $2.58 | | | | | |
| C) $3.04 | | | | | |
| D) $3.58 | | | | | |
| Is the put option in-the- | | | | | |
| money, at-the-money, or out- | | | | | |
| of-the money? | | | | | |
| A) ITM | | | | | |
| B) ATM | | | | | |
| C) OTM | | | | | |
| D) None of the above | | | | | |
| lethal injection | Familiar with 5 forms | 1 | Raw | long | short |
| electrocution | of execution that are | | | | |
| lethal gas | still used in the US | | | | |
| hanging | | | | | |
| firing squad | | | | | |
| All of the following are a type | 1-RM test | 1 | Solution | question | answer |
| of test to determine VO 2max | | | | | |
| EXCEPT: | | | | | |
| An automatic response to | What is a reflex? | 1 | Pure | answer | question |
| certain stimuli | | | Question | | |
| HTN (≥130/80 mmHg) w | Diuretics | 1 | Raw | long | short |
| Diabetes Mellitus, all are | ACEis | | | | |
| first-line | ARBs | | | | |
| | CCBs | | | | |
| conditioned stimulus (CS) | an originally neutral | 1 | Raw | short | long |
| | stimulus that, after | | | | |
| | being paired with an | | | | |
| | unconditioned | | | | |
| | stimulus, takes on the | | | | |
| | ability to bring about | | | | |
| | the response that | | | | |
| | originally followed | | | | |
| | the unconditioned | | | | |
| | stimulus; musical | | | | |
| | tone | | | | |
| Services which provide | Personal care support | 0 | Raw | long | short |
| assistance in performing daily | | | | | |
| living activities such as | | | | | |
| bathing, dressing, grooming | | | | | |
| and going to the toilet. | | | | | |
| to see | Scop | 0 | Raw | long | short |
| Letter G in Image 75 | C. Phase encoding | 0 | MCQ | question | answer |
| represents: | step | | | | |
| A. Radiofrequency (RF) | | | | | |
| B. Frequency encoding step | | | | | |
| C. Phase encoding step | | | | | |
| D. Free induction decay (FID) | | | | | |
| E. Peak signal for echo | | | | | |
| semicircular canals support | rotational movement | 0 | FITB | question | answer |

### 2.4 Example—Training Module Using a Training Set

To develop a module that classifies whether the answer side of a flashcard is appropriate for the multiple choice question (MCQ) format in study modes, a sample of 5,000 MCQ sets was collected and analyzed. This module considers the first side of a term as the prompt side and the opposite side as the answer side. These sets are labeled based on the suitability of the study direction, considering the term context. When reviewing terms for forming MCQ type flashcards, key traits of unsuitable study directions are identified, including: (1) a side of a flashcard consists of long text; (2) both sides of the flashcard consist of a long text; (3) a side of the flashcard includes an explicit question prompt, except for translation terms; (4) each side of the flashcard includes an explicit question prompt; (5) a side of the flashcard lacks an explicit question prompt but contextually serves as the better prompt; (6) a side of the flashcard features a list; (7) both sides of the flashcard features lists; (8) at least one side contains multiple question prompts; and (9) a side of the flashcard presents an MCQ prompt without providing options.

In some cases, during inference, when determining that neither side of a flashcard is highly likely to be suitable for use as the prompt side, a randomly selected side may be used. Alternatively, when a flashcard is part of a set, a set-level preference for the study direction may be determined based on the study direction of other flashcards in the set, as further described below.

Based on the labeling process, approximately 10% of the terms are identified as having the incorrect study direction in the study modes. Some of these instances align with multiple identified characteristics, while others fall into uncategorized reasons. To enhance prediction accuracy and generalize the approach for determining a study direction, separate algorithms for each question type (MCQ, Flashcard, Written) are implemented to predict whether a side of a term is unsuitable to be used as the answer side, using features derived from the term context. Table 8 below shows examples of terms that receive good and bad labels.

TABLE 8

| | “Answer” showed in | Good (1)/ | |
|---|---|---|---|
| “Question” showed in Learn mode | Learn mode | Bad (0) | reason |
| This is two period American put option | A, B | 0 | multiple |
| with 2 years maturity. Underlying asset | | | questions |
| price at current time is $100 and u(up | | | |
| factor in the binomial tree) is 1.05 and | | | |
| d(down factor in the binomial tree) is | | | |
| 0.95. The exercise price is $100 and risk | | | |
| free rate is 1%. | | | |
| What is the put option price at current | | | |
| time? | | | |
| A) $2.04 | | | |
| B) $2.58 | | | |
| C) $3.04 | | | |
| D) $3.58 | | | |
| Is the put option in-the-money, at-the- | | | |
| money, or out-of-the money? | | | |
| A) ITM | | | |
| B) ATM | | | |
| C) OTM | | | |
| D) None of the above | | | |
| lethal injection | Familiar with 5 forms | 0 | Wrong |
| electrocution | of execution that are | | direction: |
| lethal gas | still used in the US | | It's clearer |
| hanging | | | to prompt |
| firing squad | | | with the |
| | | | answer side |
| All of the following are a type of test to | 1-RM test | 0 | incomplete |
| determine VO 2max EXCEPT: | | | question |
| An automatic response to certain stimuli | What is a reflex? | 0 | Wrong |
| | | | direction: |
| | | | answer has |
| | | | question |
| | | | prompt |
| HTN (≥130/80 mmHg) w Diabetes | Diuretics | 0 | list |
| Mellitus, all are first line | ACEis | | |
| | ARBs | | |
| | CCBs | | |
| conditioned stimulus (CS) | an originally neutral | 0 | answer is |
| | stimulus that, after | | too long |
| | being paired with an | | |
| | unconditioned stimulus, | | |
| | takes on the ability to | | |
| | bring about the | | |
| | response that originally | | |
| | followed the | | |
| | unconditioned stimulus; | | |
| | musical tone | | |
| Services which provide assistance in | Personal care support | 1 | Correct |
| performing daily living activities such as | | | RAW |
| bathing, dressing, grooming and going to | | | flashcard |
| the toilet. | | | |
| to see | Scop | 1 | Correct |
| | | | RAW |
| | | | flashcard |
| Letter G in Image 75 represents: | C. Phase encoding step | 1 | Correct |
| A. Radiofrequency (RF) | | | MCQ |
| B. Frequency encoding step | | | flashcard |
| C. Phase encoding step | | | |
| D. Free induction decay (FID) | | | |
| E. Peak signal for echo | | | |
| semicircular canals support | rotational movement | 1 | Correct |
| | | | FITB |
| | | | flashcard |

### 2.5 Recommendation Models

MCQ recommendation model 218 is configured to determine a study direction for terms to be shown in the MCQ Question type in the study modes. In some cases, MCQ recommendation model 218 can be implemented as Gradient Boosted Trees (GBT) algorithm. The GBT can be implemented using any suitable approach. For instance, GBT may be implemented using a scikit-learn library. In an embodiment, the scikit-learn GBT software can be tuned using the following hyperparameters shown in TABLE 9 below.

TABLE 9

| Learning_Rate | Max_Depth | N_Estimators | Subsample |
|---|---|---|---|
| 0.01-0.1 | 5-10 | 10-50 | 0.8-1 |

In some cases, learning_rate—0.05, max_depth—7, n_estimators—20, and subsample—0.8. Herein, learning_rate is a learning rate of the GBT, max_depth is a maximum depth of a tree of the GBT, and n_estimators are the number of decision trees in the ensemble of trees comprising GBT.

To utilize Gradient Boosted Trees (GBT) for determining study direction for a term for the MCQ Question type in the study modes, an approach may include feature extraction, labeling, training, and prediction stages. Feature extraction may be an initial step, where relevant features are extracted from the flashcards to differentiate between a prompt side and a response side. These features could include textual attributes such as word frequency, length, or presence of specific keywords, along with any pertinent metadata associated with the flashcards. Following feature extraction, each side of the flashcards is labeled to indicate whether it represents a prompt or a response side. For instance, one side could be labeled as “Prompt,” or “Question” while the other side is labeled as “Response,” or “Answer.” Subsequently, a GBT classifier is trained using the extracted features and corresponding labels. This classifier learns to predict whether a given side of a flashcard is a prompt side or a response side so that the term can form a proper MCQ in the study modes based on the input features.

During the training process, each flashcard is represented as a set of features extracted from its sides, with the corresponding label indicating whether each side is a prompt or a response side so that the term can form a proper MCQ in the study modes. The GBT minimizes a loss function (e.g., logistic loss for binary classification) to determine optimal decision boundaries between prompt and response sides. The ensemble of decision trees is built sequentially, with each tree trained to correct errors made by previous trees. Gradient descent optimization iteratively adjusts parameters (e.g., tree structure, leaf values) to minimize the loss function.

Further, hyperparameters such as learning rate, maximum depth, and number of trees are tuned to prevent overfitting and optimize the model's performance on unseen data. The model's performance is evaluated on a separate validation set to monitor generalization ability and fine-tune hyperparameters. Finally, the trained model is tested on a separate test set to assess its performance on unseen flashcards. By following this approach, GBT classifiers can effectively determine which side of a flashcard contains a prompt and which side contains a response based on their respective features. Determining the study direction involves identifying which side serves as the prompt and which side serves as the response, as the study direction involves presenting the prompt side first, followed by the response side.

During the inference phase, MCQ recommendation model 218 receives flashcard features determined by the term format processing and classification module 212. The flashcard features are presented as an input for processing 216. MCQ recommendation model 218 then identifies the study direction, which involves determining which side of the flashcard should be presented first as the prompt side, and which side should follow as the response side. Additionally, in certain cases, input for processing 216 may include not only the flashcard features but also the data content from both the first and second sides of the flashcard.

Flashcard recommendation model 220 is configured to determine a study direction for flashcards to be shown in the Flashcard Question type in the study modes. Since Flashcard Question type includes fewer restrictions that MCQ Question types in the study modes, an embodiment of flashcard recommendation model 220 may be programmed to use a rule-based algorithm based on flashcard features (e.g., shown in TABLES 2 and 4) to determine which side is not suitable to be used as the response side, and which side have a reasonable likelihood to be used as the response side. A reasonable likelihood may be a likelihood that is above a certain likelihood threshold such as 0.5, 0.6, 0.7, 0.8, 0.9, 0.95, or a likelihood threshold ranging between 0.5 to 1 including all the possible values in between. Some of the possible rules for determining the study direction may include determining that the side of a flashcard is not a response side if it is blank, if it contains a question prompt or prompt that resembles an MCQ prompt, or if the text on that side of the flashcard is too long. For example, if the text length exceeds a certain character threshold, such as 100, 200, 300, 400, 500 characters, or higher, this may indicate that the side is not suitable to be presented as the prompt.

Additionally, detecting whether a side of a flashcard comprises a prompt rather than a response for a flashcard of Flashcard Question type may rely on linguistic cues and structural features. Such cues may include the presence of interrogative pronouns like “who,” “what,” “where,” “when,” “why,” and “how” at the sentence's outset, thereby implying a question, which may be further confirmed by the sentence's termination with a question mark (?). Additionally, questions often exhibit an inverted word order compared to declarative statements, as seen in phrases like “Are you coming?” compared to “You are coming.” Auxiliary verbs frequently precede the main verb in questions, including verbs like “do,” “does,” “is,” “are,” “can,” and “will.” In spoken language, rising intonation towards a sentence's conclusion typically signifies a question. Even within a sentence, the presence of question words such as “how” or “why” can signal a question.

It should be noted that, in some cases, the contextual understanding of the text can provide valuable insights into discerning whether the text serves as a question or an answer. Through analyzing these linguistic features, NLP MLMs can be trained to automatically classify sentences as questions or answers.

Similar to flashcard recommendation model 220, written recommendation model 222 is configured to determine a study direction for flashcards to be shown in the Written Question type in the study modes. Since Written Question type includes fewer restrictions that MCQ Question type in the study modes, an embodiment of written recommendation model 222 may be programmed to use a rule-based algorithm based on flashcard features (e.g., shown in TABLES 2 and 4) to determine which side is not suitable to be used as the response side, and which side have a reasonable likelihood to be used as the response side. Similar to flashcard recommendation model 220, the rules for determining study direction may include determining that the side of a flashcard is not a response side (e.g., not the second side that needs to be presented to the user) if it is blank or if it contains a question prompt or prompt that resembles an MCQ prompt. Furthermore, if a text on a side of a flashcard does not include question cues such as interrogative pronouns like “who,” “what,” “where,” “when,” “why,” and “how,” and/or question marks, and/or inverted word order, and the text is of significant length (e.g., greater than a predetermined threshold which can be, for example, above a few hundred characters such as above 100, 200, 300, and the like), then that side may be determined to be an answer as it contains an extended response to a written question.

Output result of one of MCQ recommendation model 218, flashcard recommendation model 220, or written recommendation model 222 can be further processed in post-processing recommendation module 224 to determine if the output needs to be determined by side answer data 214, instead of the data provided by one of MCQ recommendation model 218, flashcard recommendation model 220, or written recommendation model 222. For example, if side answer data 214 provides a likelihood (or probability) p₁>0.5 that a particular side of a flashcard is a question (e.g., a first side of the flashcard), the post-processing module 224 may be configured to determine that that side is the prompt side based on the side answer data 214. In such mode of operation side answer data 214 is selected to overwrite any determination of one of MCQ recommendation model 218, flashcard recommendation model 220, or written recommendation model 222.

Alternatively, in some cases, a combined approach may be used. For example, if side answer data 214 provides a likelihood p₁ and one of MCQ recommendation model 218, flashcard recommendation model 220, or written recommendation model 222 provides a likelihood p₂ a total estimated likelihood may be determined as P=w₁p₁+w₂p₂ with weights selected based on statistical analysis of data. For instance, w₁=w₂=0.5 may be selected, or if some preference is given to side answer data 214, weight w₁ can be selected such that w₁>w₂. The sum of the weights is configured to be unity. In an example implementation, the weights can be selected using quantitative analysis techniques such as least squares regression. Using such approach, predictions such as p₁ and p₂ are considered independent variables, while actual outcomes (or true probabilities) are regarded as the dependent variables. Regression analysis is then employed to calculate coefficients (weights) aimed at minimizing the disparity between the predicted and actual outcomes. The true probabilities can be estimated using historical data based on the frequency or proportion of occurrences of a particular study direction over a set of flashcards.

### 2.6 Generating Training Sets

In certain scenarios, training sets can be generated using a suitable machine learning model (MLM). For instance, a generating MLM might be programmed to receive a collection of historical flashcards and produce new flashcards incorporating features from these historical ones. Moreover, the generating MLM could be designed to appropriately label the generated flashcards for training purposes. For example, when training an MLM like MLM 213 within term format processing and classification module 212, the generating MLM could assign a classification label or specify the format of the flashcard, such as a MCQ, True/False, RAW, Fill-In-The-Blank, Pure Question, or Solution.

In the context of training an MLM like the MCQ classifier 261 illustrated in FIG. 2B, a corresponding generating MLM might be configured to designate the sides of the generated flashcards as either a prompt side or a response side, thereby indicating the study direction for these flashcards.

In some instances, an adversarial generating MLM may be utilized to train any of the MLMs discussed herein. Such a model could identify flashcards that are poorly categorized, for instance, by MLM 213, or those for which the study direction is not well-defined by the MCQ classifier 261. Subsequently, it could generate challenging flashcards that pose difficulties for MLM 213 or the MCQ classifier 261. Similarly, an adversarial generating MLM could be applied to any of the other MLMs outlined in this context.

### 2.7 Set-Level Study Direction Preference

By integrating recommendation algorithms with unanswerable flagging, embodiments achieve term-level predictions on whether a card side is appropriate for use as a response for a specific flashcard type. However, it's common for both sides of a term to be deemed suitable. To refine the choice further, an embodiment can be programmed to consider the context of a set of flashcards, operating under the hypothesis that set creators typically have a specific direction in mind.

For instance, TABLE 10 below illustrates an example set comprising six terms, where the first two terms could use either side as the prompt, but the remaining four should consistently use the left side. This pattern suggests the set creator's preference for studying from the side 1.

TABLE 10

| Side 1 | Side 2 |
|---|---|
| Pearson's r | Tests for relationships between two |
| | variables |
| Coheds d | The statistic used for measuring the |
| | effect size between two means |
| You are given the following results, F-4.3, | ANOVA yields F value statistics |
| df = 3.12, p < 05. Which test was employed to find | |
| these results? | |
| You are given the following results F = 4.3, | No, p is greater than 05 |
| df = 3.12, p > 05. Is there a significant difference in | |
| the means? | |
| When the control group means are higher than the | Negative |
| experimental group means, generally the Cohen's | |
| d will be | |
| Chi-square results are expressed as: | Frequencies and percentages |

Therefore, an embodiment can be programmed to apply this set-level preference to the first two flashcards, prioritizing the first side as the prompt side. In some cases, the set-level preference study direction may be determined by first determining a study direction for each individual term in the set of terms, and then identifying a most frequently used study direction for that set of terms as the set-level preference study direction.

Further, in some embodiments, a study direction for any of the flashcards within the set of the flashcards that do not adhere to the set-level preference study direction, may be updated with the set-level preference study direction. For instance, the study direction may be replaced with the set-level preference study direction for any one of the set of the flashcards that do not match the set-level preference study direction.

In some cases, a subset of the set of flashcards can be selected for determining a set-level preference by analyzing study directions for each flashcard in such subset of flashcards. Subsequently, a most frequently used study direction for that subset of flashcards can be selected as a set-level preference study direction for the set of flashcards. In one implementation, a subset of flashcards from the set of flashcards can be selected by selecting flashcards randomly. A subset of terms may include, for example, 10 to 50 percent of all of the flashcards of the set of flashcards.

To systematize this process, an embodiment can be programmed to execute a heuristic that identifies the set-level preferred answer side by examining which side more frequently contains explicit question prompts. In cases where both sides present question prompts in equal measure, the decision is based on which side is more frequently recommended as the response side. This method ensures alignment between term and set-level preferences, thereby enhancing the study experience by honoring the intentions of set creators.

As shown in FIG. 2A, such determination of study direction based on the set-level preferences may be performed by a set level module 226. For example, set level module 226 may be configured to determine a likelihood of a study direction based on set-level preference.

In some cases, study direction determined based on the set level preference may overwrite study direction determined by post-processing module 224.

### 2.8 Combine Term-Level Recommendation and Set-Level Preference

Through the combination of term-level recommendations and set-level preferences, an embodiment orchestrates a set of guidelines to determine the order of card sides to be used as the response side, with the resulting priority sequence being the outcome. The rules are outlined as follows: Firstly, if one side is recommended while the other isn't, priority is given to the recommended side, considering the non-recommended side only if the recommended side is deemed answerable. This approach is referred to as a “single recommended side” approach. Secondly, when both sides are recommended, the side preferred at the set level is listed first, followed by the other side. This approach is referred to as a “both sides recommended” approach. In cases where neither side is recommended, prioritization is based on answerability, with deference to the set-level preference if both are answerable. This approach is referred to as a “no recommended sides” approach. Finally, if both sides are found to be answerable, the set-level preferred answer side is listed first, followed by the other side. This approach is referred to as a “both sides answerable” approach.

The priority order determination, as described above, is performed by a priority order determination module 228, as shown in FIG. 2A. As a result, for each term of a set of terms a priority order for each side of a slide is determined as shown by output 230. For example, for terms in a first set with a set id 1, a priority order for MCQ Question type is side 1 following by side 2, for Written Question type in set id 1, the priority order is side 2 following by side 1.

The application of these rules is further exemplified in TABLE 11, demonstrating how the embodiment determines the prioritization of each side of a term across various question types. In various cases, a given term can be presented as a Multiple-Choice Question (MCQ) type, a Written Question type, or a Flashcard Question type, as previously discussed. For instance, referring to the example about the flashcard related to John Adams mentioned earlier, the study recommendations for that term may vary depending on whether it is displayed as an MCQ, a Written Question, or a Flashcard Question. These differences in study direction recommendations are further detailed in TABLE 11 below.

TABLE 11

| | | | | Written | Flashcard |
|---|---|---|---|---|---|
| Set | | | MCQ | Answer | Answer |
| ID | Word (side 1) | Definition (side 2) | Priority | Priority | Priority |
| 111 | sea fog | What type of fog occurs | [word] | [word] | [word] |
| | | when wind heated by | | | |
| | | warm ocean water blows | | | |
| | | over cool ocean water? | | | |
| 111 | skip | The instruction | [word] | [ ] | [word] |
| | | includes an implied | | | |
| | | address. | | | |
| | | a. skip | | | |
| | | b. rotate | | | |
| | | c. stack | | | |
| | | d. push | | | |
| 111 | germ line | Mutations must occur in | [word] | [word] | [word] |
| | | the cells that | | | |
| | | produce either eggs or | | | |
| | | sperm. | | | |
| 111 | What is used as | B | [word] | [word] | [word] |
| | anti-anxiety | | | | |
| | agents, muscles | | | | |
| | relaxers, sedatives, | | | | |
| | and hypnotics? | | | | |
| | A. Opioid | | | | |
| | B. | | | | |
| | Benzodiazepines | | | | |
| | C. Antibiotics | | | | |
| | D. Antivirals | | | | |
| 111 | How do we reduce | | [word] | [word] | [word] |
| | the number of | | | | |
| | unemployed | | | | |
| | people? | | | | |
| 222 | The clearest | higher education | [definition] | [definition] | [definition] |
| | liberalizing | | | | |
| | influence on | | | | |
| | individual | | | | |
| 222 | Walrus | Sea mammal | [definition] | [definition] | [definition] |
| 333 | decrease the | increased viscosity | [word, | [word, | [definition, |
| | velocity of blood | | definition] | definition] | word] |
| | flow | | | | |

Referring to TABLE 11, for the set with ID 111, the priority list indicates [word] for flashcard having “sea fog” displayed on the first side for Flashcard Question type. This means that the word side (side 1) is recommended as the prompt side for this flashcard. At least some other flashcards in this set, such as those with “skip” and “germ line,” may also use the word as the prompt side, as shown in TABLE 11. Also, for MCQ Question type regarding anti-anxiety agents, the word side (side 1) is recommended as the prompt side.

For the set with ID 333, the priority list for the “decrease the velocity of blood flow” flashcard for Flashcard Question type, is [definition, word]. This scenario suggests that both sides are suitable for use as prompt sides across these question types. In various embodiments, the prioritization reflects a sophisticated understanding of the content's adaptability to different Question types, ensuring that the study experience is optimized for effectiveness and user engagement.

TABLE 12 shows examples of various content types that can be used to form sets of terms.

TABLE 12
Concept and Definitions

| | |
|---|---|
| 1^{st} Amendment | Freedom of Religion, Speech, of the Press, |
| | Assembly, and Petition |
| 2^{nd} Amendment | Protects the people's right to bear arms |
| 3^{rd} Amendment | No soldier can be quartered in a home without the |
| | permission of the |

Vocabulary

| | |
|---|---|
| el este | the east |
| el norte | the north |
| el noreste | the northeast |
| el noroeste | the northwest |

Questions and Answers

| | |
|---|---|
| When does DNA replication occur? | S phase |
| Where does DNA replication start? | The ori |
| What is created once the DNA opens? | Replication Bubble |
| The county clerk and register of any | $10 |
| county with whom a certificate of | |
| official character has been filed shall | |
| collect for the filing- A $2, B $4, C $5, | |
| D $10 | |
| A notary public who is removed from | Misdemeanor |
| office and then executes any instrument | |
| as a notary public is guilty of a - A. | |
| Violation, B. Petty offense, C. | |
| Misdemeanor, D Felony | |

Answers and Questions

| | |
|---|---|
| rapid rise time | What is a key reason why a high frequency |
| | generator is recommended for an interventional |
| | radiography room? |
| An inverted grayscale image made from | What is the “mask” image? |
| the “scout” image | |
| Timing of contrast delivery in the | What is the major reason to using an automatic |
| procedure is critical | injector for procedures? |

Mixed

| | |
|---|---|
| not true | A z-score is an area under the normal curve. |
| What conditions would produce a | A z-score corresponding to an area located entirely |
| negative z- score? | in the left side of the curve would produce a |
| | negative z-score |
| 85^{th} percentile | data value associated with an area of 085 to its left |
| calculating z score | http://wwwsocscistatisticscom/tests/ztest/zscorecalculatoraspx |

TABLE 13 shows a set of flashcards having a first and a second side.

TABLE 13

| Side 1 | Side 2 |
|---|---|
| The distribution of IQ scores is a | The mean is 0 and the standard deviation is 1. |
| nonstandard normal distribution with a | Standardizing the scores to z scores makes the |
| mean of 100 and a standard deviation of | distribution a standard normal distribution. |
| 15. What are the values of the mean and | |
| standard deviation after all IQ scores | |
| have been standardized by converting | |
| them to z scores using [math | |
| hA1:M4ere] | |
| What conditions would produce a | A z-score corresponding to an area located entirely |
| negative z- score? | in the left side of the curve would produce a |
| | negative z-score. |
| Not true | A z-score is an area under the normal curve. |
| 85^{th} percentile | data value associated with an area of 085 to its |
| | left |

As shown in TABLES 14A-C, the embodiments of the method described herein are configured to consistently select a first side as a prompt side, thus ensuring consistency in study direction for the set of terms:

TABLE 14A
The distribution of IQ scores is a nonstandard normal distribution with a mean of 100 and a
standard deviation of 15. What are the values of the mean and standard deviation after all IQ
scores have been standardized by converting them to z scores using z = (x − μ)/σ
Choose matching definition:
(1) - determine you're looking at area to the right because they must be at least
70 find z score for 70 = 2.56, area to the left = 0.9948, we need area to right 1 −
0.9948 = 0.0052, convert to %%, 52%
(2) - a z-score corresponding to an area located entirely in the
left side of the curve would produce a negative z-score
(3) -the mean is 0 and the standard deviation is 1
(4) - a z-score is an area under the normal curve
Don't know

TABLE 14B
A Z-Score is an area under the normal curve.
Choose matching term
(1) The distribution of IQ scores is a nonstandard normal distribution with a mean of 100 and
a standard deviation of 15. What are the values of the mean and standard deviation after all IQ
scores have been standardized by converting them to z scores using z = (x − μ)/σ
(2) 85^{th} percentile.
(3) What conditions would produce a negative z-score?
(4) not true
Don't know?

TABLE 14C
What conditions would produce a negative z-score?
Choose matching definition
(1) the mean is 0 and the standard deviation is 1. Standardizing the scores to z scores makes
the distribution a standard normal distribution.
(2) data value associated with an area of 0.85 to its left
(3) a Z-Score is an area under the normal curve
(4) a z-score corresponding to an area located entirely in the left side of the curve would
produce a negative z-score.
Don't know?

TABLE 14D
data value associated with an area of 0.85 to its left
Choose matching term
(1) what conditions would produce a negative z-score?
(2) not true
(3) the distribution of IQ scores is a nonstandard normal distribution with a mean of 100 and a
standard deviation of 15. What are the values of the mean and standard deviation after all IQ
scores have been standardized by converting them to z scores using z(x − μ)/sigma?
Don't know?

FIG. 2B shows a workflow pipeline 201 for classifying flashcards. This pipeline may be another pipeline for determining a study direction for a set of flashcards. An input 210, consisting of a set of flashcards, is provided term testing module 235, which is configured to determine if a flashcard from the set of flashcards is an MCQ flashcard. This determination can be made by parsing the text content of the flashcard and identifying if it includes multiple choice questions. If module 235 determines that the term is an MCQ flashcard (Yes path in FIG. 2B), an MCQ parser 240 further determines the type of MCQ included in the flashcard, such as True/False or a question with more than two options. The MCQ parser generates a first set of flashcard features 251 for MCQs with more than two options or a second set of flashcard features 252 for True/False cards. Subsequently, the first set of flashcard features 251 or second set of flashcard features 252 is provided to the respective MCQ classifier 261 or True/False classifier 262 to determine which side of the flashcard includes the MCQ or True/False prompt and which side includes the response. Classifiers 261 and 262 may be any suitable classifiers, such as rule-based or machine learning models (e.g., based on random forests, neural networks like RNNs, transformers, and the like).

Similarly, when the term testing module 235 determines that a flashcard is not an MCQ (No path in FIG. 2B), a term format random forest classifier 241 further classifies the flashcard type as RAW, FITB, Pure Question, or Solution. Depending on this classification, one of flashcard feature sets 253-257 is provided to the respective classifiers 263-267 to determine which side includes the prompt and which side includes the response. Like classifiers 261 and 262, classifiers 263-267 may be rule-based or machine learning models. After completing the classification, a post-processing 270 may further correct the classification based on certain rules. For example, post-processing 270 may correct a classification if it determines that at least one side includes a question mark or if one side is too long to be interpreted as an answer. Any suitable rules based on the flashcard features outlined in TABLES 2 and 4 can be used. Upon completion of the workflow pipeline, an output 272 is generated, including: Side 1 text data and features, Side 2 text data and features, term format (e.g., MCQ, RAW, FITB, Pure Question, Solution), as well as Side 1 and Side 2 formats, which can be “prompt” or “response.”

In some embodiments, classifiers 261 and 262 may be used to perform term side format classification. The result(s) of the classification may be used to determine study direction when the terms are MCQ, True/False, Fill-in-the-blank, Pure question, and solution. In an example embodiment, classifiers 261 and 262 may be used for determining whether flashcard format is MCQ or True/False. For example, classifiers 261 and 262 may be regular expression (regex) based classifiers. Classifiers 261 and 262 are configured to detect the flashcard side that has a MCQ or T/F prompt and label that side as a question side, and the opposite side as an answer side. The question side may be determined using regex, which can include specific pattern matching in text, which can help identify question-like structures. Example methods and patterns that can be used to detect questions in flashcard text using regex include question mark detection, detection of common question words, detection of auxiliary verbs, as well as full sentence check. For question mark detection regex ex1= “\?” or ex2=“\?.*$” can be used. Regex ex2 may ensure that the question mark is at the end of a sentence and not used in another context. For common question words detection, the methods and patterns can include determining if sentences start with words such as “Who,” “What,” “Where,” “When,” “Why,” or “How,” and the like. To detect these words, a regex may be used that searches for question words such as these at the beginning of a line or after a punctuation mark (indicating the start of a new sentence). For example, regex ex3=“(?:\hat{ }|\.\s|\?\s|\!\s) (Who|What|Where|When|Why|How)\b” can be used to determine whether the words “Who,” “What,” “Where,” “When,” “Why,” or “How” are present. For auxiliary verbs a regex ex4= “(?:\hat{ }|\.\s|\?\s|\!\s) (Is|Are|Can|Do|Does|Will|Would|Should) \b” can be used to determine whether the words “Is,” “Are,” “Can,” “Do,” “Does,” “Will,” “Would,” or “Should” are present.

Further, in an example embodiment, Raw classifier 263 may be configured to label a side containing more characters of text than the other side (herein, such side is referred to as a longer side) as the first side, while labeling the other side (i.e., shorter side) as the second side. In some cases, the first side can be identified as a question side. Alternatively, in other cases, the other side can be identified as a question side.

Additionally, classifiers 264 and 265 may include one or more machine learning models such as random forests (similar to other machine learning models being random forests as discussed herein) configured to determine the question side of a flashcard.

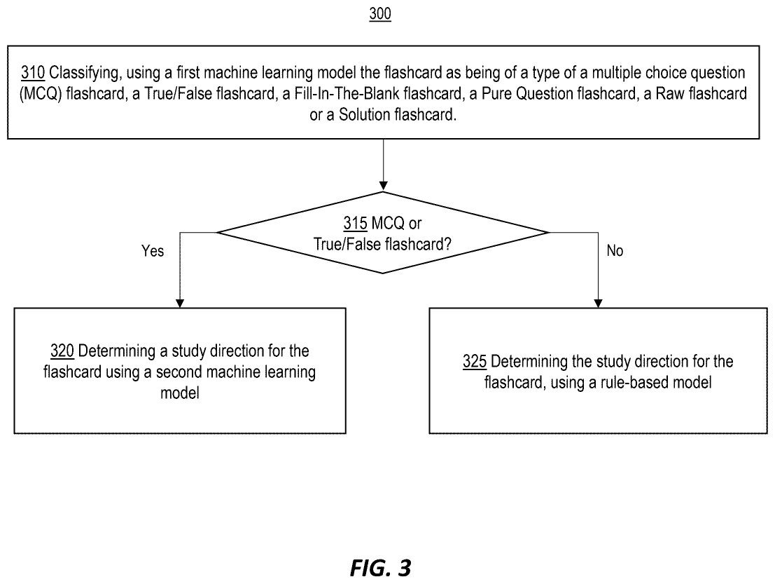

FIG. 3 shows an example method 300 for determining a study direction for a flashcard that can be performed by a processor executing instructions that may include rule-based and machine learning-based approaches for determining the study direction. In the example embodiment, method 300 includes at step 310 classifying, using a first machine learning model, a flashcard from a set of flashcards as being represented as a multiple choice question (MCQ) flashcard, a True/False flashcard, a Fill-In-The-Blank flashcard, a Pure Question flashcard, a Raw flashcard, or a Solution flashcard. The first machine learning model may be, for example, term format processing and classification module 212, as shown in FIG. 2A. At step 315, if the flashcard is classified as a MCQ flashcard or a True/False flashcard (step 315, Yes), method 300 is configured to proceed to step 320 for determining a study direction for the flashcard using a second machine learning model. The second machine learning model may be, for example, MCQ Classifier 261 or a True/False Classifier 262, as has been discussed above herein.

At step 315, if the flashcard is classified as a Fill-In-The-Blank flashcard, Pure Question flashcard, Raw flashcard, or Solution flashcard (step 315, No), method 300 is configured to proceed to step 325 for determining the study direction for that flashcard, using a rule-based model.

The rule-based model may be designed to identify whether the first or second side of a flashcard contains a question. In some embodiments, when the rule-based model detects a question on either side, that side is selected as the prompt side of the flashcard. In various scenarios, the rule-based model evaluates whether the first or second side of a particular flashcard contains a question by utilizing one or more of the methods described herein. Upon confirming that a question is present, the model then selects the corresponding side as the prompt side for that flashcard.

In some cases, determining that the first or the second side of the second flashcard contains the question comprises at least one of: identifying a question mark in text of the first side or the second side of the second flashcard; identifying interrogative pronouns in the text of the first side or the second side of the second flashcard; or identifying an inverted word order present within the text of the first side or the second side of the second flashcard.

If the flashcard is a Fill-In-The-Blank flashcard, the rule-based approach may include identifying a blank space in a text of the first side or the second side of the second flashcard and selecting a side of the second flashcard containing the identified blank space as a prompt side of the second flashcard.

If the flashcard is a True/False flashcard, the rule based approach may include identifying a response side of the second flashcard as the side of the flashcard that includes words “True” or “False” and has a length of a text that is less than a predetermined true-false threshold value.

In various cases, the first machine learning model is trained using a first training set of flashcards labeled with a label corresponding to MCQ Question type, True/False flashcard, Fill-In-The-Blank flashcard, Pure Question flashcard, Raw flashcard, or Solution flashcard. The determining of the study direction includes determining which one of the first side or the second side of the flashcard is a prompt side of the flashcard, and wherein the prompt side of the flashcard is a side of a flashcard that is being presented to a user prior to presenting to the user a response side of the flashcard. Additionally, the second machine learning model is trained using a second training set of flashcards wherein each flashcard in the second training set of flashcards has a side that is labeled as a prompt side and/or as a response side.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

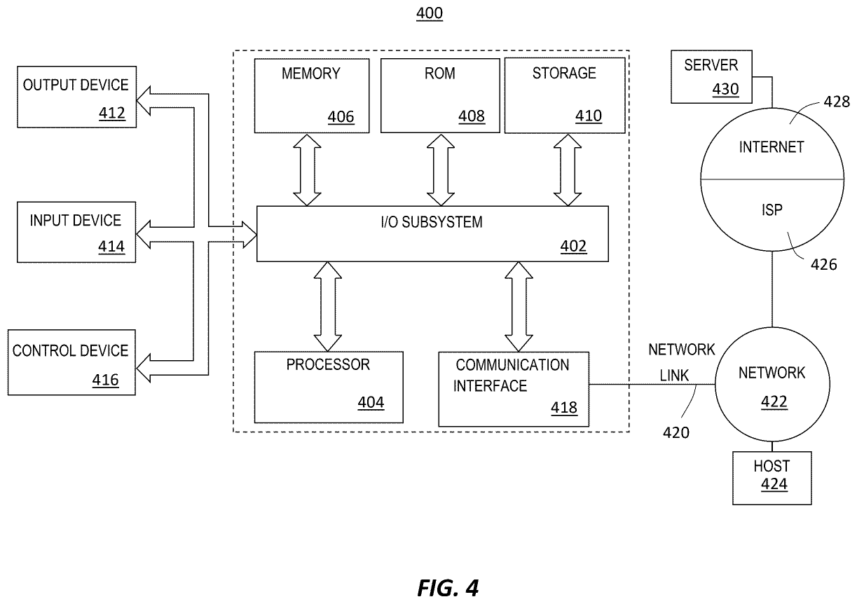

FIG. 4 is a block diagram that illustrates an example computer system with which an embodiment may be implemented. In the example of FIG. 4, a computer system 400 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 400 includes an input/output (I/O) subsystem 402, which may include a bus and/or other communication mechanism(s) for communicating information and/or instructions between the components of the computer system 400 over electronic signal paths. The I/O subsystem 402 may include an I/O controller, a memory controller, and at least one I/O port. The electronic signal paths are represented schematically in the drawings, such as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU), or a digital signal processor or ARM processor. Processor 404 may comprise an integrated arithmetic logic unit (ALU) or be coupled to a separate ALU.

Computer system 400 includes one or more units of memory 406, such as a main memory, coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during the execution of instructions to be executed by processor 404. Such instructions, when stored in non-transitory computer-readable storage media accessible to processor 404, can render computer system 400 into a special-purpose machine customized to perform the operations specified in the instructions.

Computer system 400 includes non-volatile memory such as read-only memory (ROM) 408 or other static storage devices coupled to I/O subsystem 402 for storing information and instructions for processor 404. The ROM 408 may include various forms of programmable ROM (PROM), such as erasable PROM (EPROM) or electrically erasable PROM (EEPROM). A unit of persistent storage 410 may include various forms of non-volatile RAM (NVRAM), such as FLASH memory, solid-state storage, magnetic disk, or optical disks such as CD-ROM or DVD-ROM and may be coupled to I/O subsystem 402 for storing information and instructions. Storage 410 is an example of a non-transitory computer-readable medium that may be used to store instructions and data which, when executed by the processor 404, cause performing computer-implemented methods to execute the techniques herein.

The instructions in memory 406, ROM 408, or storage 410 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 400 may be coupled via I/O subsystem 402 to at least one output device 412. In one embodiment, output device 412 is a digital computer display. Examples of a display that may be used in various embodiments include a touchscreen display, a light-emitting diode (LED) display, a liquid crystal display (LCD), or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections, or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. The control device 416 may be a touchpad, a mouse, a trackball, or cursor direction keys for communicating direction information and command selections to processor 404 and for controlling cursor movement on an output device 412, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 414 may include a combination of multiple input devices, such as a video camera and a depth sensor.

In another embodiment, computer system 400 may comprise an Internet of Things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders, and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server computer 430.

Computer system 400 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 402. Transmission media can also be acoustic or light waves generated during radio-wave and infrared data communications.

Various forms of media may carry at least one sequence of at least one instruction to processor 404 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to a bus or I/O subsystem 502. Communication interface 418 provides a two-way data communication coupling to a network link(s) 420 directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 422 broadly represents a local area network (LAN), wide-area network (WAN), campus network, internetwork, or any combination thereof. Communication interface 418 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may connect through network 422 to a host computer 424.

Furthermore, network link 420 may connect through network 422 or to other computing devices via internetworking devices and/or computers operated by an Internet Service Provider (ISP) 426. ISP 426 provides data communication services through a worldwide packet data communication network called Internet 428. A server computer 430 may be coupled to Internet 428. Server computer 430 broadly represents any computer, data center, virtual machine, or virtual computing instance with or without a hypervisor or computer executing a containerized program system such as DOCKER or KUBERNETES. Server computer 430 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 400 and server computer 430 may form elements of a distributed computing system that includes other computers, a processing cluster, a server farm, or other organizations of computers that cooperate to perform tasks or execute applications or services. Server computer 430 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 430 may comprise a web application server that hosts a presentation layer, application layer, and data storage layer, such as a relational database system using a structured query language (SQL) or no SQL, an object store, a graph database, a flat file system or other data storage.

Computer system 400 can send messages and receive data and instructions, including program code, through the network(s), network link 420, and communication interface 418. In the Internet example, server computer 430 might transmit a requested code for an application program through Internet 428, ISP 426, local network 422, and communication interface 418. The received code may be executed by processor 404 as it is received and/or stored in storage 410 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the disclosure have been described with reference to numerous specific details that may vary from implementation to implementation. Accordingly, the specification and drawings are to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A computer-implemented method comprising:
receiving a set of flashcards, each flashcard in the set of flashcards having a first side and a second side;
classifying, using a first machine learning model, one or more flashcards of the set of flashcards, the classifying including determining a particular flashcard type of each of the one or more flashcards, wherein the particular flashcard type is a multiple choice question (MCQ) flashcard, a True/False flashcard, a Fill-In-The-Blank flashcard, a Pure Question flashcard, a Raw flashcard, or a Solution flashcard, and wherein the first machine learning model is trained using a first training set of flashcards and each flashcard of the first training set has an associated label corresponding to an (MCQ flashcard, a True/False flashcard, a Fill-In-The-Blank flashcard, a Pure Question flashcard, a Raw flashcard, or a Solution flashcard; and
determining that a flashcard of the one or more flashcards has been classified as an MCQ flashcard by the first machine learning model; and
determining a study direction for the flashcard using a second machine learning model;
wherein determining the study direction for the flashcard comprises determining which one of the first side or the second side of the flashcard is a prompt side that is presented to a user prior to a response side; and
wherein the second machine learning model is trained using a second training set of flashcards and each flashcard of the second training set of flashcards has a flashcard side that is labeled as a prompt side or a response side.

2. The computer-implemented method of claim 1, wherein the first machine learning model is configured to extract one or more flashcard features including one or more bullets or a question mark, wherein the one or more flashcard features comprise an input to the second machine learning model.

3. The computer-implemented method of claim 2, further comprising one or more of: determining a language for each side of the flashcard, determining whether a side of the flashcard includes a numerical value, or determining a number of tokens of the first and the second side of the flashcard.

4. The computer-implemented method of claim 1, wherein the flashcard is a first flashcard, the computer-implemented method further comprising determining that a second flashcard of the one or more flashcards has been classified as a is Fill-In-The-Blank flashcard, a Pure Question flashcard, a Raw flashcard, or a Solution flashcard and determining a study direction for the second flashcard using a rule-based model.

5. The computer-implemented method of claim 4, wherein the rule-based model includes instructions comprising determining that the first or the second side of the second flashcard contains a question and, in response, selecting the side of the second flashcard containing the question as a prompt side of the second flashcard.

6. The computer-implemented method of claim 5, wherein the determining that the first or the second side of the second flashcard contains the question comprises at least one of:
identifying a question mark in text of the first side or the second side of the second flashcard;
identifying interrogative pronouns in the text of the first side or the second side of the second flashcard; or
identifying an inverted word order present within the text of the first side or the second side of the second flashcard.

7. The computer-implemented method of claim 4, wherein the rule-based model includes instructions comprising:
determining that the second flashcard has been classified as a Fill-In-The-Blank flashcard type;
identifying a blank space in a text of the first side or the second side of the second flashcard; and
selecting a side of the second flashcard containing the identified blank space as a prompt side of the second flashcard.

8. The computer-implemented method of claim 1, wherein the flashcard is a first flashcard, the computer-implemented method further comprising determining that a second flashcard of the one or more flashcards has been classified as a True/False flashcard and identifying a response side of the second flashcard as the side of the flashcard that includes words “True” or “False” and has a length of a text that is less than a predetermined true-false threshold value.

9. The computer-implemented method of claim 1, wherein the set of flashcards includes a plurality of flashcards, the method further comprising:
determining a set-level preference study direction for the set of flashcards; and
based on a determination that the study direction for the flashcard does not match the set-level preference study direction, replacing the study direction for the flashcard with the set-level preference study direction.

10. The computer-implemented method of claim 9, wherein the determined set-level preference study direction is a selected set-level preference study direction that corresponds to a study direction for a majority of flashcards from the set of flashcards.

11. A computer-implemented method comprising:
receiving a set of flashcards, each flashcard in the set of flashcards having a first side and a second side;
classifying, using a first machine learning model, one or more flashcards of the set of flashcards as being of a particular flashcard type, wherein the first machine learning model is trained using a first training set of flashcards and each flashcard of the first training set has an associated label corresponding to a multiple choice question (MCQ) flashcard, a True/False flashcard, or a Fill-In-The-Blank flashcard, a Pure Question flashcard, a Raw flashcard or a Solution flashcard;
determining that the particular flashcard type for a flashcard of the one or more flashcards is the Pure Question flashcard, the Raw flashcard or the Solution flashcard; and
determining a study direction for the flashcard using a rule-based model, wherein the determining of the study direction for the flashcard comprises determining which one of the first side or the second side of the flashcard is a prompt side that is presented to a user prior to a response side.

12. The computer-implemented method of claim 11, wherein the rule-based model includes instructions comprising determining that the first or the second side of the flashcard contains a question and, in response, selecting the side of the flashcard containing the question as the prompt side of the flashcard.

13. The computer-implemented method of claim 12, wherein the determining that the first or the second side of the flashcard contains the question comprises at least one of:
identifying a question mark in text of the first side or the second side of the flashcard;
identifying interrogative pronouns in the text of the first side or the second side of the flashcard; or
identifying an inverted word order present within the text of the first side or the second side of the flashcard.

14. The computer-implemented method of claim 11, wherein the rule-based model includes instructions comprising:
determining that the flashcard is of a Fill-In-The-Blank flashcard type; and
identifying a blank space in a text of the first side or the second side of the flashcard; and
selecting a side of the flashcard containing the identified blank space as the prompt side of the flashcard.

15. The computer-implemented method of claim 12, wherein the set of flashcards includes a plurality of flashcards, the method further comprises:
determining a set-level preference study direction for the set of flashcards; and
based on a determination that a study direction of one or more flashcards of the set of flashcards does not match the set-level preference study direction, replacing the study direction of the one or more flashcards with the set-level preference study direction.

16. The computer-implemented method of claim 15, wherein determining the set-level preference study direction includes selecting the set-level preference study direction that corresponds to the study direction for a majority of flashcards from the set of flashcards.

17. A computer-implemented method comprising:
receiving a set of flashcards, each flashcard in the set of flashcards having a first side and a second side;
classifying, using a first machine learning model, each flashcard of the set of flashcards as being of one of a multiple choice question (MCQ) flashcard, a True/False flashcard, a Fill-In-The-Blank flashcard, a Pure Question flashcard, a Raw flashcard, or a Solution flashcard, wherein the first machine learning model is trained using a first training set of flashcards and each flashcard of the first training set has an associated label corresponding to the multiple choice question (MCQ) flashcard, the True/False flashcard, the Fill-In-The-Blank flashcard, the Pure Question flashcard, the Raw flashcard or the Solution flashcard; and
determining a study direction for a flashcard from the set of flashcards by determining which one of the first side or the second side of the flashcard is a prompt side that is presented to a user prior to a response side, wherein:
for the multiple choice question (MCQ) flashcard and the True/False flashcard, performing the determining using a second machine learning model, that is being trained using a second training set of flashcards, wherein each flashcard of the second training set of flashcards has a flashcard side that is labeled as the prompt side or the response side; and
for the Fill-In-The-Blank flashcard, the Pure Question flashcard, the Raw flashcard or the Solution flashcard, performing the determining using a rule-based model.

18. The computer-implemented method of claim 17, wherein the first machine learning model is configured to extract one or more flashcard features including one or more bullets or a question mark, wherein the one or more flashcard features comprise an input to the second machine learning model.

19. The computer-implemented method of claim 17, wherein the rule-based model includes instructions comprising determining that the first or the second side of a flashcard from the set of flashcards contains a question and, in response, selecting the side of the flashcard containing the question as the prompt side of the flashcard.

20. The computer-implemented method of claim 19, wherein the determining that the first or the second side of the flashcard contains the question comprises at least one of:
identifying a question mark in text of the first side or the second side of the flashcard;
identifying interrogative pronouns in the text of the first side or the second side of the flashcard; or
identifying an inverted word order present within the text of the first side or the second side of the flashcard.
